(19) United States
(12) Patent Application Publication
(10) Pub. No.: US 2011/0015401 A1
(43) Pub. Date: Jan. 20, 2011

(54) Metal-Catalyzed Carbon-Fluorine Bond Formation

(75) Inventors: Stephen L. Buchwald, Newton, MA (US); Donald Allen Watson, Newark, DE (US); Mingjuan Su, Singapore (SG); Georgiy Teverovskiy, Brooklyn, NY (US)

Correspondence Address: FOLEY HOAG, LLP;PATENT GROUP, WORLD TRADE CENTER WEST, 155 SEAPORT BLVD, BOSTON, MA, 02110, US

(73) Assignee: Massachusetts Institute of Technology, Cambridge, MA (US)

(21) Appl. No.: 12/834,993

(22) Filed: Jul. 13, 2010

Related U.S. Application Data
(60) Provisional application No. 61/225,057, filed on Jul. 13, 2009.

(51) Int. Cl. C07F 15/00; C07F 17/02

(52) U.S. Cl. 548/103; 556/22; 556/21; 548/101; 548/402; 549/212

(57) ABSTRACT

One aspect of the invention relates to a metal-catalyzed conversion of aryl halides and sulfonates to the corresponding aryl fluorides. Another aspect of the invention relates to a metal-catalyzed conversion of heteroaryl halides and sulfonates to the corresponding heteroaryl fluorides. Another aspect of the invention relates to a metal-catalyzed conversion of vinyl halides and sulfonates to the corresponding vinyl fluorides. In certain embodiments, simple fluoride sources, such as AgF and CsF, are used. In certain embodiments, the transformations tolerate a wide range of functional groups, allowing for introduction of fluorine atoms into highly functionalized organic molecules.

### RELATED APPLICATIONS

This application claims the benefit of priority to U.S. Provisional Patent Application Ser. No. 61/225,057, filed Jul. 13, 2009; the entirety of which is hereby incorporated by reference.

### GOVERNMENT SUPPORT

This invention was made with support provided by the National Institutes of Health (Grant No. R37-GM46059); therefore, the government has certain rights in the invention.

### BACKGROUND

A large number of pharmaceuticals and agrochemicals contain fluorinated aromatic groups, often making them superior to their non-fluorinated analogs in terms of solubility, bioavailability, and metabolic stability. K. Müller, C. Faeh, F. Diederich, Science 317, 1881 (2007); H.-J. Böhm, D. Banner, S. Bendels, M. Kansy, B. Kuhn, K. Müller, U. Obst-Sander, M. Stahl, ChemBioChem 5, 637 (2004); G. Gerebtzoff, X. Li-Blatter, H. Fischer, A. Frentzel, A. Seelig, ChemBioChem 5, 676 (2004); and P. Jeschke, ChemBioChem 5, 570 (2004). Furthermore, radioactive ¹⁸F-labelled organic compounds are also widely used as contrast agents for positron emission tomography (PET). M. Phelps, Proc. Natl. Acad. Sci. U.S.A. 97, 9226 (2000); and S. M. Ametamey, M. Honer, P. A. Schubiger, Chem. Rev. 108, 1501 (2008).

Traditional methods for the introduction of a fluorine atom into an aromatic framework, such as direct fluorination (G. Sandford, J. Fluorine Chem. 128, 90 (2007)), the conversion of amines via the aryldiazonium salt with HBF₄ (Balz-Schiemann reaction) (G. Balz, G. Schiemann, Ber. Dtsch. Chem. Ges. 60, 1186 (1927)) or the nucleophilic substitution of electron-poor bromo- or chloroarenes with K F (Halex reaction) (G. C. Finger, C. W. Kruse, J. Am. Chem. Soc. 78, 6034 (1956)), as well as the more recent transformation of aryl iodides with CuF₂ (V. V. Grushin, U.S. Pat. No. 7,202,388 (2007)) all require harsh reaction conditions that are incompatible with many functional groups. A modified Balz-Schiemann process, particularly for use in PET (V. W. Pike, F. I. Aigbirhio, J. Chem. Soc., Chem. Commun., 2215 (1995)), employs aryliodonium salts that are produced under highly acidic or oxidizing conditions (T. L. Ross, J. Ermert, C. Hocke, H. H. Coenen, J. Am. Chem. Soc. 129, 8018 (2007)). In a recent significant advance, it was shown that the Halex reaction can be performed at room temperature when using anhydrous tetrabutylammonium fluoride, but the scope is limited and the fluoride source is not readily amenable to the preparation of ¹⁸F-labelled compounds (H. Sun, S. G. DiMagno, Angew. Chem. Int. Ed. 45, 2720 (2006)).

Recent advances have demonstrated that transition-metal promoted Ar—F bond formation can be achieved with use of electrophilic “F+” reagents such as Selectfluor® or N-fluoropyridinium salts. K. L. Hull, W. Q. Anani, M. S. Sanford, J. Am. Chem. Soc. 128, 7134 (2006); N. D. Ball, M. S. Sanford, J. Am. Chem. Soc. 131, 3796 (2009); T. Furuya, H. M. Kaiser, T. Ritter, Angew. Chem. Int. Ed. 47, 5993 (2008); T. Furuya, T. Ritter, J. Am. Chem. Soc. 130, 10060 (2008); T. Furuya, A. E. Strom, T. Ritter, J. Am. Chem. Soc. 131, 1662 (2009); A. W. Kaspi, A. Yahav-Levi, I. Goldberg, A. Vigalok, Inorg. Chem. 47, 5 (2008); D. C. Powers, T. Ritter, Nature Chemistry, Advance Online Publication, Jun. 7, 2009. These extremely interesting reactions are believed to proceed via high-valent Pd or Ag intermediates and have been shown to allow access to highly functionalized aryl fluorides. However, these reactions have some limitations with respect to preparative chemistry. In many cases, stoichiometric amounts of the transition metal must be employed since the oxidation state of the metal formed via reductive elimination of Ar—F (e.g., Pd^{II}) is not generally able to oxidatively add to an aryl halide or pseudohalide as required in a catalytic process. In the reported examples that proceed with a catalytic quantity of metal, specific directing groups on the substrate are required to facilitate a C—H activation process, thus diminishing the general applicability of the methods utilized. K. L. Hull, W. Q. Anani, M. S. Sanford, J. Am. Chem. Soc. 128, 7134 (2006); N. D. Ball, M. S. Sanford, J. Am. Chem. Soc. 131, 3796 (2009); and X. Wang, T.-S. Mei, J.-Q. Yu, J. Am. Chem. Soc 131, 7520 (2009). An additional drawback of this approach is that electrophilic ¹⁸F reagents are not available with high specific activity, lessening the utility of these methods for PET applications. T. L. Ross, J. Ermert, C. Hocke, H. H. Coenen, J. Am. Chem. Soc. 129, 8018 (2007); and G. Angelini, M. Speranza, A. P. Wolf, C. Y. Shiue, J. Fluorine Chem. 27, 177 (1985).

In sum, despite their importance, fluorinated aromatic organic molecules remain difficult to synthesize. Thus, the development of new and general methods for their preparation that overcome the limitations of those techniques currently in use is of great interest.

### SUMMARY

One aspect of the invention relates to a metal-catalyzed direct conversion of aryl halides and sulfonates into their corresponding aryl fluorides. Another aspect of the invention relates to a metal-catalyzed direct conversion of heteroaryl halides and sulfonates into their corresponding heteroaryl fluorides. Another aspect of the invention relates to a metal-catalyzed direct conversion of vinyl halides and sulfonates into their corresponding vinyl fluorides. In certain embodiments, simple fluoride sources, such as AgF and CsF, are used. In certain embodiments, the transformation tolerates a number of functional groups, allowing for introduction of fluorine atoms into highly functionalized organic molecules.

### BRIEF DESCRIPTION OF THE FIGURES

FIG. 1 depicts a scheme showing a metal-catalyzed fluorination; the proposed catalytic cycle for the same; and examples of two ligands which may be used for the metal-catalyzed fluorination.

FIG. 2 depicts a scheme showing the preparation of and reductive elimination from [2.PdAr(F)] complexes; and an x-ray structure of complex 4.

FIG. 3 depicts the catalytic conversion of aryl bromide 8 to aryl fluoride 7.

FIG. 4 depicts a table showing the optimization of fluorination of aryl triflates.

FIG. 5 depicts examples of the fluorination of aryl triflates.

FIG. 6 depicts a table showing regioisomers for the tolyl and anisole series, and a comparison with the ratios obtained from a reported fluorination of bromoaryls that proceeds via a benzyne intermediate. V. V. Grushin, W. J. Marshall, Organometallics 27, 4825 (2008).

FIG. 7 depicts a table showing the results of a particular fluorination in a number of solvents, and the results of fluorinations of other triflates which gave mixtures of regioisomeric products.

FIG. 8 depicts a representative procedure for the fluorination reaction of aryl triflates (i.e., X is —OTf).

FIG. 9 depicts (BrettPhos)Pd(2-Me,4-CF₃C₆H₃)(Br) and its ¹H NMR spectrum.

FIG. 10 depicts (BrettPhos)Pd(2-Me,4-CF₃C₆H₃)(F) (4) and its ¹H NMR spectrum.

FIG. 11 depicts (BrettPhos)Pd(2-Me,4-CNC₆H₃)(Br) and its ¹H NMR spectrum.

FIG. 12 depicts (BrettPhos)Pd(2-Me,4-CNC₆H₃)(F) (5) and its ¹H NMR spectrum.

FIG. 13 depicts the reductive elimination of (BrettPhos)Pd(2-Me,4-CF₃C₆H₃)(F) (4), and a graph depicting the effect of an additive on the reaction.

FIG. 14 depicts (BrettPhos)Pd(2-Me,4-CNC₆H₃)(F) (5), and a graph depicting the effect of an additive on the reaction.

FIG. 15 depicts the results of a particular fluorination reaction using a range of ligands.

FIG. 16 depicts the results of a particular fluorination reaction using a range of palladium sources.

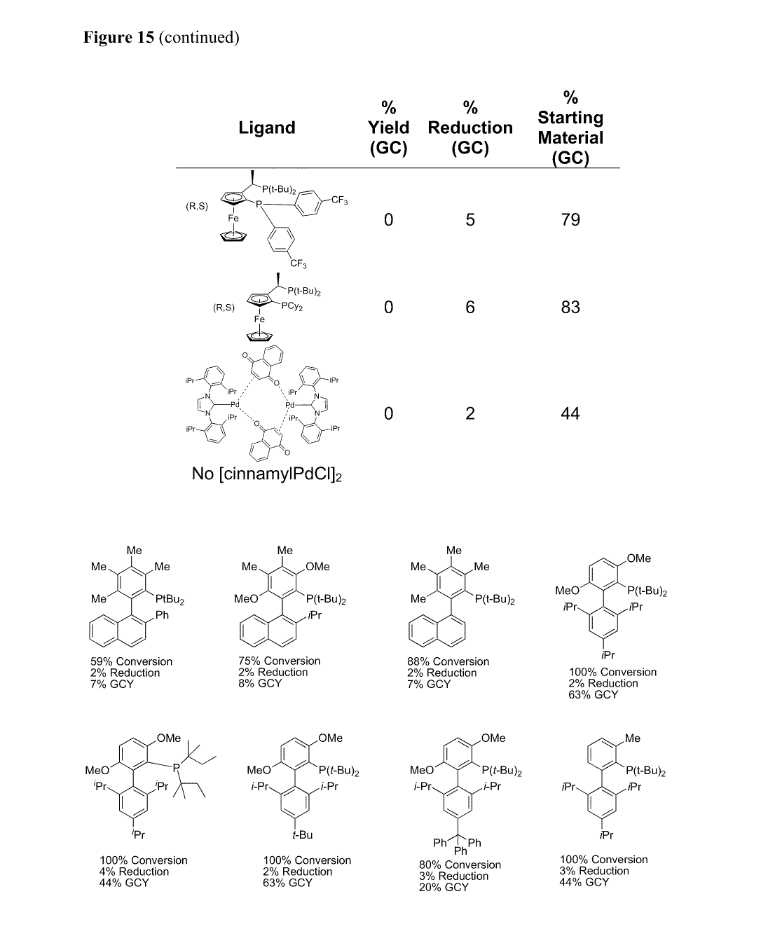

FIG. 17 depicts the results of two fluorination reactions using a range of solvents.

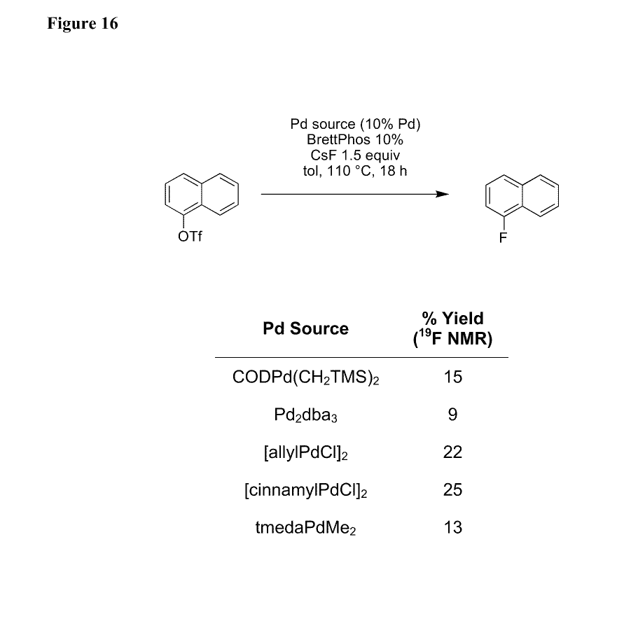

FIG. 18 depicts the results of a particular fluorination reaction using a range of additives.

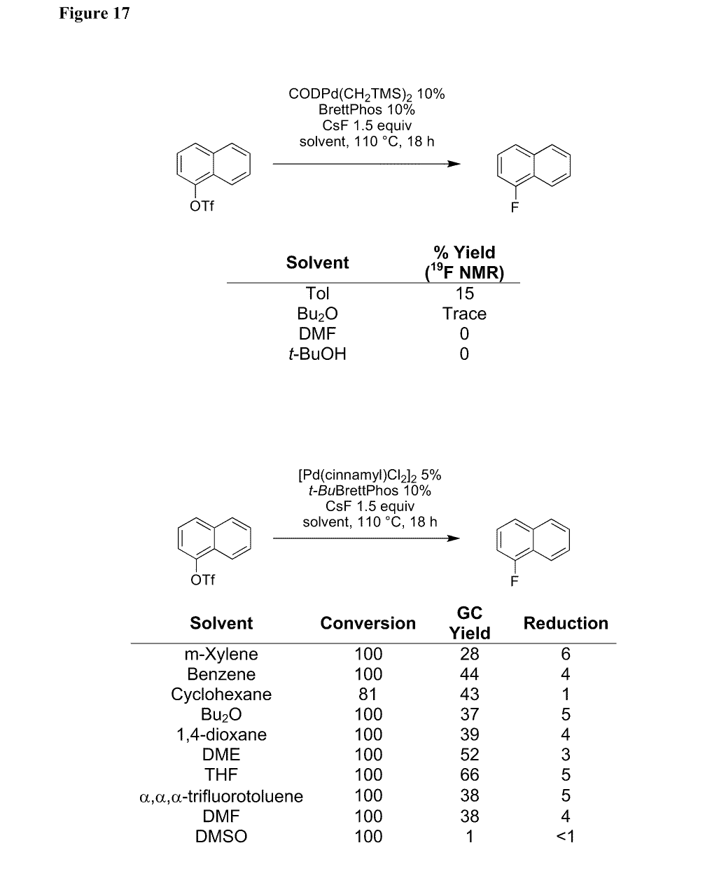

FIG. 19 depicts the conversion of 1-naphthyl trifluoromethanesulfonate to 1-fluoronaphthalene using ligand L1 at two temperatures.

FIG. 20 depicts the results of a particular fluorination reaction using chloro and iodo substrates.

### DETAILED DESCRIPTION

### Overview

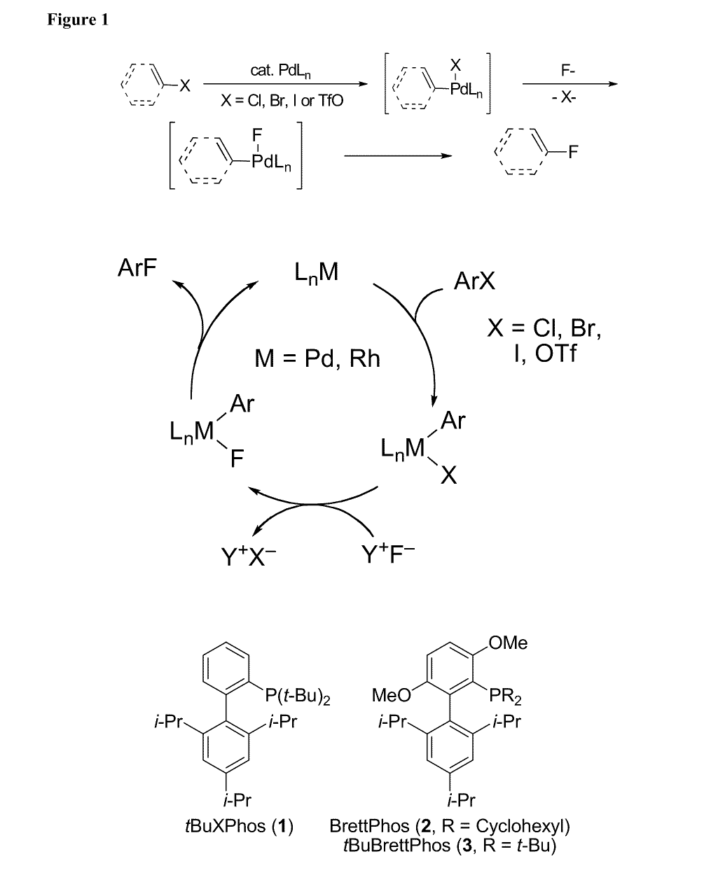

In light of the importance of fluorinated arenes and the practical limitations of current methods for their formation, the metal-catalyzed conversion of an aryl halide or sulfonate with a nucleophilic fluorine source, such as an alkali metal fluoride, to yield the corresponding aryl fluoride is a highly desirable transformation (FIG. 1, top). For a process operating at reasonable temperatures and in the absence of electrophilic reagents, high functional group compatibility and a wide substrate scope is expected. This is of particular importance for the preparation of PET imaging agents because mildly nucleophilic ¹⁸F-reagents, such as Cs¹⁸F, can be readily prepared.

Mechanistic studies of isolated [LₙMAr(F)] complexes (M=Pd, Rh) have demonstrated that reductive elimination to form an Ar—F bond is extremely challenging. G. Angelini, M. Speranza, A. P. Wolf, C. Y. Shiue, J. Fluorine Chem. 27, 177 (1985); V. V. Grushin, Chem.-Eur. J. 8, 1006 (2002); W. J. Marshall, V. V. Grushin, Organometallics 22, 555 (2003); V. V. Grushin, W. J. Marshall, J. Am. Chem. Soc. 126, 3068 (2004); W. J. Marshall, V. V. Grushin, Organometallics 23, 3343 (2004); and S. A. Macgregor, D. C. Roe, W. J. Marshall, K. M. Bloch, V. I. Bakhmutov, V. V. Grushin, J. Am. Chem. Soc. 127, 15304 (2005). In particular, Grushin's elegant work has cast doubt on whether a catalytic cycle as depicted in FIG. 1 (top) is viable.

It has been reported that reductive elimination of ArX (Ar=aryl; and X═Cl, Br, I) from a Pd^{II} intermediate is possible. A. H. Roy, J. F. Hartwig, J. Am. Chem. Soc. 123, 1232 (2001). However, the formation of stable [LₙPdAr(F)]₂ dimers may contribute to the difficulty in achieving the desired carbon-fluorine bond forming reductive elimination. D. V. Yandulov, N. T. Tran, J. Am. Chem. Soc. 129, 1342 (2007); and V. V. Grushin, W. J. Marshall, Organometallics 26, 4997 (2007).

While it was recently shown that the dimeric Pd complex [(o-tol)₃PPd(p-NO₂C₆H₄)(F)]₂ yielded 10% of para-fluoronitrobenzene upon heating in benzene in the presence of an excess of ligand, it has been questioned whether this particular reaction proceeds via a conventional reductive elimination D. V. Yandulov, N. T. Tran, J. Am. Chem. Soc. 129, 1342 (2007); and V. V. Grushin, W. J. Marshall, Organometallics 26, 4997 (2007).

Herein is disclosed what is believed to be the first example of the reductive elimination of an aryl fluoride from a well-characterized Pd^{II} complex. Based on this result, the first palladium-catalyzed method for the formation of aryl fluorides from aryl bromides with AgF and from aryl triflates with CsF has been developed.

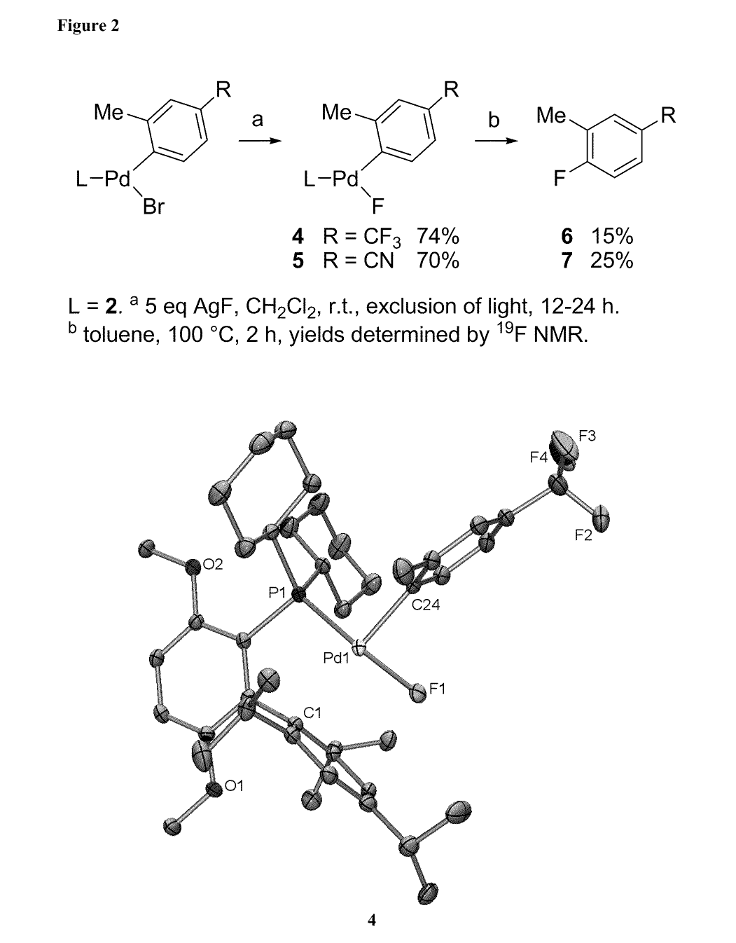

Recently, a new monophosphine ligand, BrettPhos (2), was reported for use in aryl amination reactions. NMR and crystallographic studies of [2.PdAr(X)] (X═Cl or Br) complexes revealed that they were monomeric both in solution and in the solid state. Examples of [2.PdAr(F)] complexes were prepared in order to determine if they were also monomeric and to see if 2 could be useful as a ligand in promoting reductive elimination to form Ar—F bonds. It was found that the transmetalation of the [2.PdAr(Br)] complex was best performed with AgF at room temperature in dichloromethane (FIG. 2, top). It was observed that the isolated [2.PdAr(F)] complexes exhibit a characteristic doublet in ³¹P and ¹⁹F-NMR with a coupling constant 2JPF of about 175 Hz, depending on the aryl group. The X-ray structure of 4 (Ar=2-methyl-4-trifluoromethylphenyl) confirmed the monomeric nature of the complex (FIG. 2, top).

The thermolysis of 4 and 5 was examined at 100° C. in toluene and it was found that reductive elimination to form 6 and 7 occurs in yields of 15% and 25%, respectively (FIG. 2). It was determined that these reductive eliminations take place with first order kinetics with half-lives of 14 and 16 min. The yields could be increased to 45% of 6 and 55% of 7 if the reductive eliminations were conducted in the presence of an excess of the corresponding aryl bromide. The lower yield in the absence of added aryl bromide suggests that the 2.Pd⁰ complex that results from reductive elimination further reacts with remaining [2.PdAr(F)] complex. The proposed mechanism is supported on account that no Ar′-F product was observed in a crossover experiment in which 5 was heated in the presence of Ar′Br (Ar′=2-methyl-4-methylbenzoate). Further, the ³¹P-NMR spectra of the reaction mixture after heating 4 or 5 with an excess of the corresponding ArBr showed that the oxidative-addition complexes [2.PdAr(Br)] were formed as the only phosphorous-containing products. This observation strongly suggests that LPd⁰ is formed by reductive elimination since this is the only species that can oxidatively add to the ArBr.

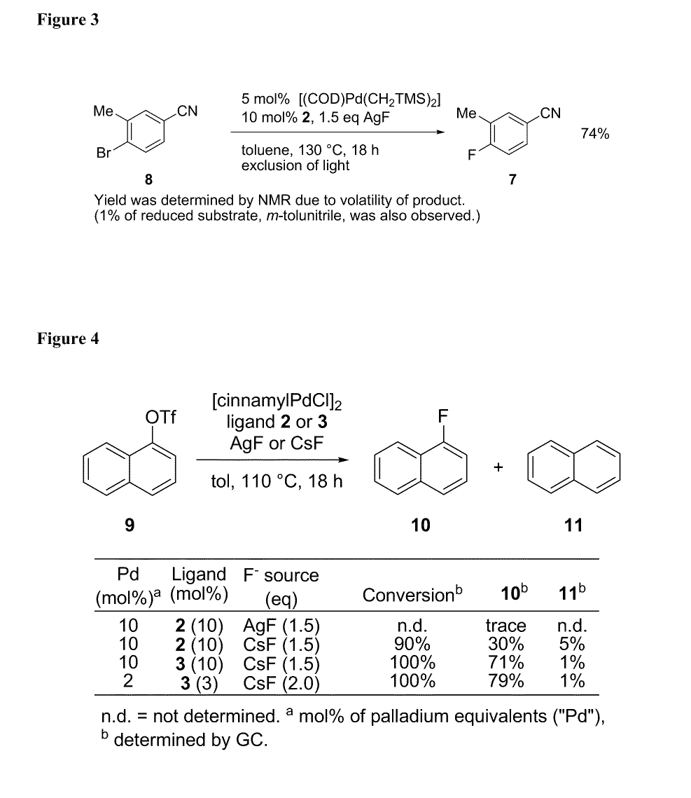

Having demonstrated that oxidative-addition, halide exchange (transmetalation) and reductive-elimination were all possible, the catalytic conversion of ArBr 8 to ArF 7 was examined. Upon treatment of 8 with AgF (1.5 equiv) and 10 mol % each of 2 and [(COD)Pd(CH₂TMS)₂] (COD=1,5-cyclooctadiene) (Y. Pan, G. B. Young, J. Organomet. Chem. 577, 257 (1999)) at 110° C. for 18 h, a 52% yield of 7 was observed, which was increased to 74% after optimization of the reaction conditions (FIG. 3). No product was detected in control experiments that omitted 2 and/or the Pd precatalyst. This constitutes the first reported example of the catalytic conversion of an aryl bromide to an aryl fluoride. However, the scope of aryl bromides that could be effectively transformed is to date limited to electron-poor substrates bearing an ortho substituent, in line with the observation that no reductive elimination took place from [2.PdAr(F)] complexes with Ar=3,5-dimethylphenyl or Ar=4-n-butylphenyl.

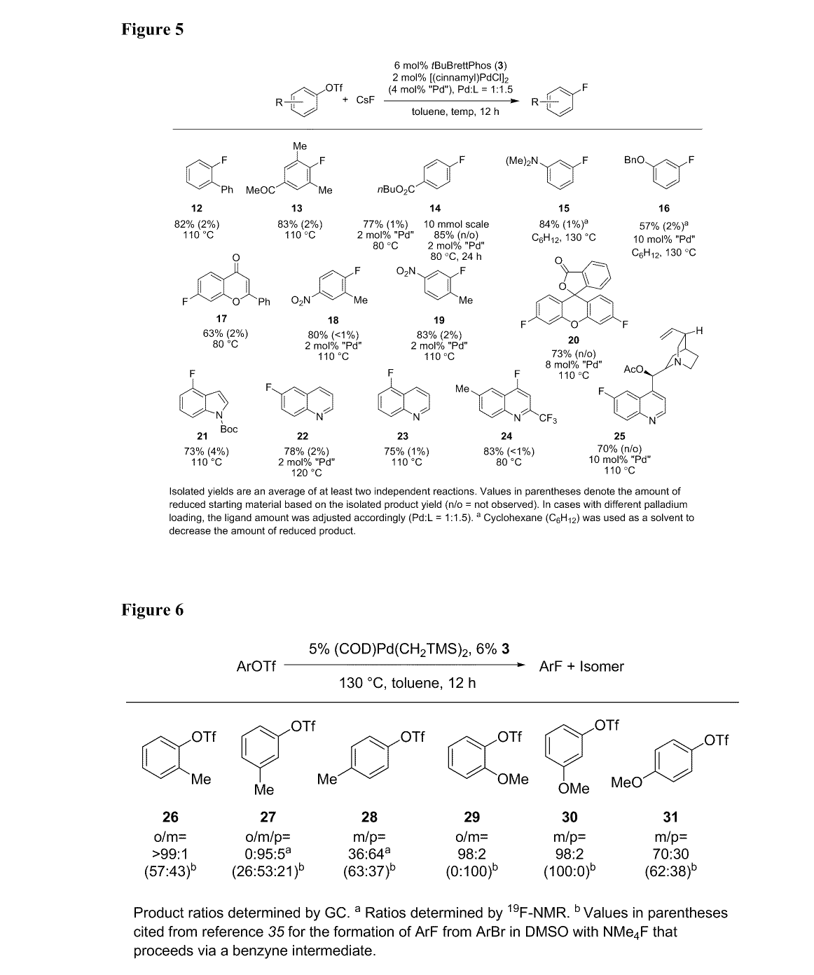

Although a reaction involving the triflate of 1-naphthol (9) provided only a trace of product 10 using AgF, employing CsF as the fluoride source gave 10 in 30% yield (FIG. 4). In addition, 5% of naphthalene (11) was also observed. It was also found that [(cinnamyl)PdCl]₂ could be used as the Pd precatalyst with a similar outcome. Overall, this result is significant as it demonstrates that the fluorination can be carried out without the need to employ a stoichiometric quantity of a noble metal component while still using a nucleophilic fluoride source.

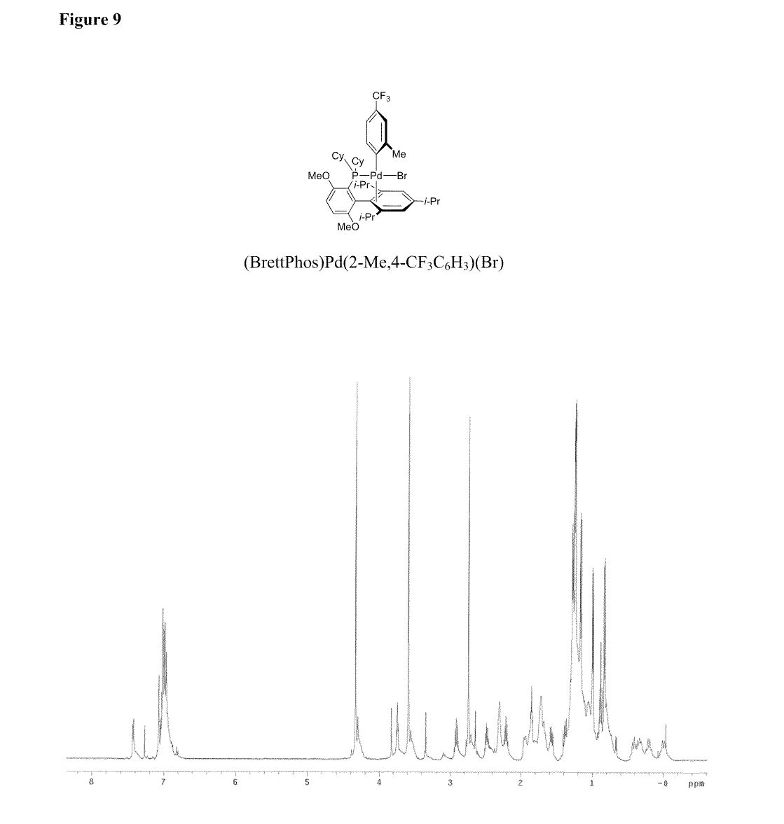

In order to optimize the reaction, a broad range of ligands were examined. It was found that only ligands closely related to 2 provided more than a trace amount of 10 (FIG. 7). Best results were obtained using tBuBrettPhos (3) as ligand; a 71% yield of 10 was realized, with only 1% of reduction product 11 observed. Further optimization of the reaction conditions increased the yield of 10 to 79%. Since the reaction proved to be sensitive to water, commercially obtained CsF was dried at 200° C. under vacuum overnight and handled in a nitrogen-filled glovebox. Replacing CsF with spray-dried KF afforded 10 in 52% yield. No reaction was observed in the absence of the catalyst, ruling out both classic S_{N}Ar and aryne mechanisms. V. V. Grushin, W. J. Marshall, Organometallics 27, 4825 (2008).

Preliminary kinetics experiments of the conversion of 9 to 10, using 5 mol % [(COD)Pd(CH₂TMS)₂] as precatalyst, 10 mol % of 3 as supporting ligand, and 3 equivalents of CsF, showed that full conversion is reached in 2.5 h in toluene at 110° C., yielding 80% of 10. Increasing the amount of CsF to 6 equivalents and adding 30 mol % of the solubilizing agent poly(ethylene glycol) dimethyl ether (Me₂PEG) led to full conversion in less than 30 min, however at a lower yield of 71%.

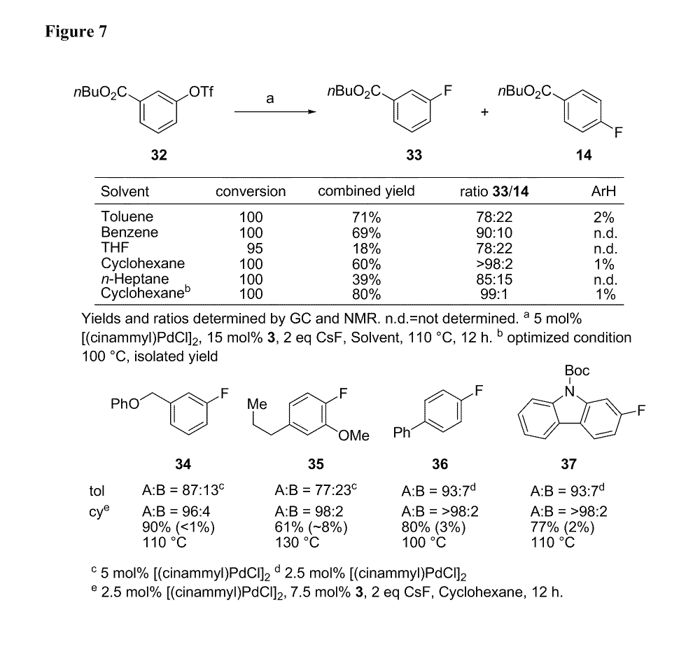

As can be seen in FIG. 5, the fluorination of aryl triflates has significant scope. Simple aromatic substrates, like biphenyl triflate, react rapidly to provide aryl fluoride 12 in high yield. Hindered substrates such as 4 acetyl-2,6-dimethylphenyl triflate are also efficiently converted to product (13). Electron-deficient ones can be transformed using only 2 mol % of catalyst (14, 18, 19). Importantly, a variety of heterocyclic substrates can also be successfully employed using these fluorination conditions. Flavones (17), indoles (21), and quinolines (22-24) all gave product in good yield. More complex aryl triflates derived from fluorescein (20) and quinine (25) could also be effectively converted to their fluorinated analogues, demonstrating that this method can be used in the preparation of pharmaceutically-related compounds. In some cases, product was formed in high yield at 80° C. (14, 17, 24). On a 10 mmol scale, the formation of 14 was successful at 80° C. without observable amounts of reduced product. In all cases, little or no reduction product was observed.

Many functional groups are tolerated, an exception being Lewis basic groups in the ortho position of the aryl triflate such as amines or carbonyl-containing ones. No reaction takes place in these instances, presumably due to the coordination of the Pd center, possibly preventing transmetalation.

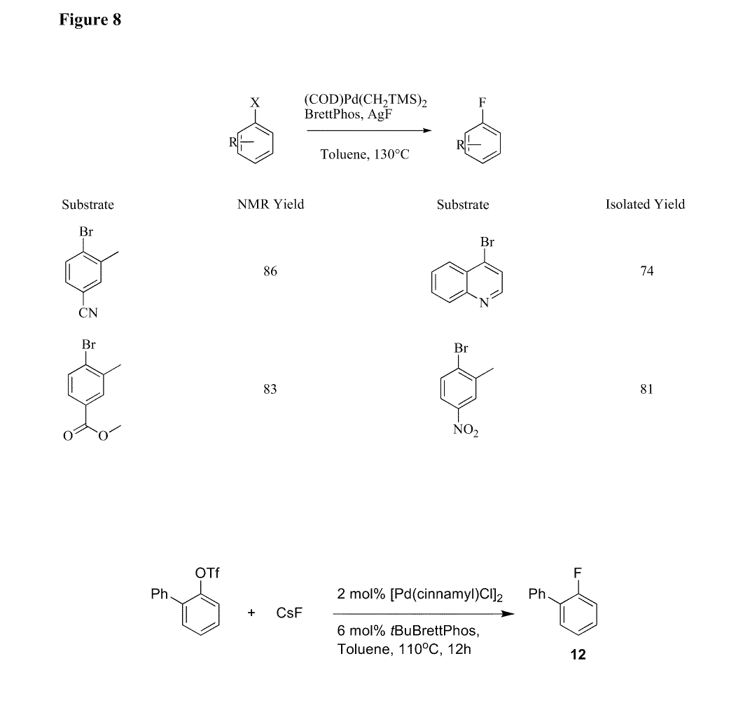

As in the Pd-catalyzed formation of Ar—O bonds, the transformation of electron-rich substrates was more challenging. Good yields were obtained at higher temperatures (130° C.). Unexpectedly, regioisomeric products were formed in a few cases (FIGS. 6 and 7).

Since control experiments did not yield any product in the absence of catalyst, it is believed that isomer formation is also a palladium-catalyzed process. Investigating a series of tolyl (26-28) and anisole (29-31) triflates it was found that for substrates 26, 27, and 29 the observed selectivities are quite distinct from those reported for a benzyne process (FIG. 6). V. V. Grushin, W. J. Marshall, Organometallics 27, 4825 (2008). Experiments with 2,6-dideuterated anisole triflate 31 showed a reduced rate of formation of the undesired regioisomer while the rate of formation of the desired product remained largely unchanged, leading to a 2.5-fold increase in selectivity in comparison to the reaction with unlabelled 31. Thus, at least for this substrate, one can conclude that two competing pathways are involved; it is evident that hydrogen abstraction is the rate-limiting or first irreversible step in regioisomer formation and that little or none of the desired isomer is formed from the path that finally leads to the regioisomer.

Further experimentation on the conversion of 32 to 33 and its regioisomer 14 revealed that the solvent polarity strongly affects the ratio of isomers formed, and the desired pathway appears to be favored in highly apolar media (FIG. 7). In most instances in which the undesired regioisomer was observed, switching the solvent from toluene to cyclohexane afforded almost exclusively the desired product. For example, fluorinated aryls 33-37 could be prepared with greater than 95:5 selectivity favoring the desired isomer. This modification provides a highly practical means to minimize formation of regioisomeric byproducts.

Based on the results discussed above, one aspect of the present invention relates to a transition metal-catalyzed fluorination reaction that comprises combining an fluoride source with a substrate aryl, heteroaryl or vinyl group bearing an activated group X. The reaction includes at least a catalytic amount of a transition metal catalyst, comprising a ligand, and the combination is maintained under conditions appropriate for the metal catalyst to catalyze the reaction.

### Substrates

Suitable substrates include compounds derived from simple aromatic rings (single or polycylic) such as benzene, naphthalene, anthracene and phenanthrene; or heteroaromatic rings (single or polycyclic), such as pyrrole, thiophene, thianthrene, furan, pyran, isobenzofuran, chromene, xanthene, phenoxathiin, pyrrole, imidazole, pyrazole, thiazole, isothiazole, isoxazole, pyridine, pyrazine, pyrimidine, pyridazine, indolizine, isoindole, indole, indazole, purine, quinolizine, isoquinoline, quinoline, phthalazine, naphthyridine, quinoxaline, quinazoline, cinnoline, pteridine, carbazole, carboline, phenanthridine, acridine, perimidine, phenanthroline, phenazine, phenarsazine, phenothiazine, furazan, phenoxazine, pyrrolidine, oxolane, thiolane, oxazole, piperidine, piperazine, morpholine and the like. In certain embodiment, the reactive group, X, is substituted on a five, six or seven membered ring (though it can be part of a larger polycycle).

In certain embodiments, the aryl substrate may be selected from the group consisting of phenyl and phenyl derivatives, heteroaromatic compounds, polycyclic aromatic and heteroaromatic compounds, and functionalized derivatives thereof. Suitable aromatic compounds derived from simple aromatic rings and heteroaromatic rings, include but are not limited to, pyridine, imidizole, quinoline, furan, pyrrole, thiophene, and the like. Suitable aromatic compounds derived from fused ring systems, include but are not limited to naphthalene, anthracene, tetralin, indole and the like.

Suitable aromatic compounds may have the formula ZₚArX, where X is an activated substituent. An activated substituent, X, is characterized as being a good leaving group. In certain embodiments, the leaving group is a group such as a halide or sulfonate. Suitable activated substituents include, by way of example only, halides such as chloride, bromide and iodide, and sulfonate esters such as triflate, mesylate, nonaflate and tosylate. In certain embodiments, the leaving group is a halide selected from iodine, bromine, and chlorine. In certain embodiments, the leaving group is a phosphonate, ammonium salt, ester or alkyloxy leaving group.

Z represents one or more optional substituents on the aromatic ring, though each occurrence of Z (p>1) is independently selected. By way of example only, each incidence of substitution independently can be, as valence and stability permit, a halogen, a lower alkyl, a lower alkenyl, a lower alkynyl, a carbonyl (e.g., an ester, a carboxylate, or a formate), a thiocarbonyl (e.g., a thiolester, a thiolcarboxylate, or a thiolformate), a ketyl, an aldehyde, an amino, an acylamino, an amido, an amidino, a cyano, a nitro, an azido, a sulfonyl, a sulfoxido, a sulfate, a sulfonate, a sulfamoyl, a sulfonamido, a phosphoryl, a phosphonate, a phosphinate, —(CH₂)ₘ—R₈₀, —(CH₂)ₘ—OH, —(CH₂)ₘ—O-lower alkyl, —(CH₂)ₘ—O-lower alkenyl, —(CH₂)ₘ—O—(CH₂)ₙ—R₈₀, —(CH₂)ₘ—SH, —(CH₂)ₘ—S-lower alkyl, —(CH₂)ₘ—S-lower alkenyl, —(CH₂)ₘ—S—(CH₂)ₙ—R₈₀, or protecting groups of the above or a solid or polymeric support; R₈₀ represents a substituted or unsubstituted aryl, aralkyl, cycloalkyl, cycloalkenyl, or heterocycle; and n and m are independently for each occurrence zero or an integer in the range of 1 to 6. P is preferably in the range of 0 to 5. For fused rings, where the number of substitution sites on the aryl group increases, p may be adjusted appropriately.

In certain embodiments, the substitution is limited to the para- and/or meta-position, relative to the X substituent. In certain embodiments, chelating substituents are excluded from the ortho-position, again relative to the X substituent.

In certain embodiments, suitable substituents Z include alkyl, aryl, acyl, heteroaryl, amino, carboxylic ester, carboxylic acid, hydrogen, ether, thioether, amide, carboxamide, nitro, phosphonic acid, hydroxyl, sulfonic acid, halide, pseudohalide groups, and substituted derivatives thereof, and p is in the range of 0 to 5. In particular, the reaction is anticipated to be compatible with acetals, amides and silyl ethers. For fused rings, where the number of substitution sites on the aromatic ring increases, p may be adjusted appropriately.

A wide variety of substrate aryl, heteroaryl and vinyl groups are useful in the methods of the present invention. The choice of substrate will depend on the desired product, and an appropriate substrate will be made apparent to the skilled artisan by these teachings. It will be understood that the substrate preferably will not contain any interfering functionalities.

### Catalysts

It is contemplated that the “transition metal catalyst” of the present invention, as that term is used herein, shall include any catalytic transition metal and/or catalyst precursor as it is introduced into the reaction vessel and which is, if necessary, converted in situ into the active form, as well as the active form of the catalyst which participates in the reaction.

In certain embodiments, the transition metal catalyst complex is provided in the reaction mixture is a catalytic amount. In certain embodiments, that amount is in the range of 0.0001 to 20 mol % or 0.05 to 15 mol %, or is about 10 mol %, with respect to the substrate. In the instance where the molecular formula of the catalyst complex includes more than one metal, the amount of the catalyst complex used in the reaction may be adjusted accordingly. By way of example, Pd₂(dba)₃ has two metal centers; and thus the molar amount of Pd₂(dba)₃ used in the reaction may be halved without sacrificing catalytic activity.

In certain embodiments, catalysts containing palladium and nickel are preferred. It is expected that these catalysts will perform similarly because they are known to undergo similar reactions, namely oxidative-addition reactions and reductive-elimination reactions, which are thought to be involved in the formation of the products of the present invention.

In general, any transition metal (e.g., having d electrons) may be used to form the catalyst, e.g., a metal selected from one of Groups 3-12 of the periodic table or from the lanthanide series. However, in certain embodiments, the metal will be selected from the group of late transition metals, e.g., preferably from Groups 5-12 and even more preferably Groups 7-11. For example, suitable metals include platinum, palladium, iron, nickel, ruthenium and rhodium. The particular form of the metal to be used in the reaction is selected to provide, under the reaction conditions, metal centers which are coordinately unsaturated and not in their highest oxidation state. The metal core of the catalyst should be a low valent transition metal, such as Pd or Ni with the ability to undergo oxidative addition to A—X bond. In certain embodiments, the transition metal is Rh or Fe, which are isoelectronic with Pd(0).

To further illustrate, suitable transition metal catalysts include soluble or insoluble complexes of platinum, palladium and nickel. Nickel and palladium are particularly preferred and palladium is most preferred. A low-valent metal center is presumed to participate in the catalytic carbon-heteroatom or carbon-carbon bond forming sequence. Thus, the metal center is desirably in the low-valent state or is capable of being reduced to metal(0). Suitable soluble palladium complexes include, but are not limited to, (COD)Pd(CH₂TMS)₂, [Pd(cinnamyl)Cl]₂, tris(dibenzylideneacetone) dipalladium [Pd₂(dba)₃], bis(dibenzylideneacetone) palladium [Pd(dba)₂] and palladium acetate. Alternatively, particularly for nickel catalysts, the active species for the oxidative-addition step may be in the metal (+1) oxidation state.

The coupling can be catalyzed by a palladium catalyst which palladium may be provided in the form of, for illustrative purposes only, Pd/C, PdCl₂, Pd(OAc)₂, (CH₃CN)₂PdCl₂, Pd[P(C₆H₅)₃]₄, and polymer supported Pd(0). In other embodiments, the reaction can be catalyzed by a nickel catalyst which nickel may be provided in the form of, for illustrative purposes only, Ni(acac)₂, NiCl₂[P(C₆H₅)]₂, Ni(1,5-cyclooctadiene)₂, Ni(1,10-phenanthroline)₂, Ni(dppf)₂, NiCl₂(dppf), NiCl₂(1,10-phenanthroline), Raney nickel and the like, wherein “acac” represents acetylacetonate.

The catalyst will preferably be provided in the reaction mixture as metal-ligand complex comprising a bound supporting ligand, that is, a metal-supporting ligand complex. The ligand effects can be key to favoring, inter alia, the reductive elimination pathway or the like which produces the products, rather than side reactions such as β-hydride elimination. The ligand, if chiral, can be provided as a racemic mixture or a purified stereoisomer.

The catalyst complex may include additional supporting ligands as required to obtain a stable complex. Moreover, the ligand can be added to the reaction mixture in the form of a metal complex, or added as a separate reagent relative to the addition of the metal.

The supporting ligand may be added to the reaction solution as a separate compound or it may be complexed to the metal center to form a metal-supporting ligand complex prior to its introduction into the reaction solution. Supporting ligands are compounds added to the reaction solution which are capable of binding to the catalytic metal center. In some preferred embodiments, the supporting ligand is a chelating ligand. Although not bound by any theory of operation, it is hypothesized that the supporting ligands suppress unwanted side reactions as well as enhance the rate and efficiency of the desired processes. Additionally, they typically prevent precipitation of the catalytic transition metal. Although the present invention does not require the formation of a metal-supporting ligand complex, such complexes have been shown to be consistent with the postulate that they are intermediates in these reactions and it has been observed the selection of the supporting ligand has an effect on the course of the reaction.

The supporting ligand is present in the range of 0.0001 to 40 mol % relative to the limiting reagent. The ratio of the supporting ligand to catalyst complex is typically in the range of about 1 to 20. These ratios are based upon a single metal complex and a single binding site ligand. In instances where the ligand contains additional binding sites (i.e., a chelating ligand) or the catalyst contains more than one metal, the ratio is adjusted accordingly. By way of example only, the supporting ligand BINAP contains two coordinating phosphorus atoms and thus the ratio of BINAP to catalyst is adjusted downward to about 1 to 10. Conversely, Pd₂(dba)₃ contains two palladium metal centers and the ratio of a non-chelating ligand to Pd₂(dba)₃ is adjusted upward to 1 to 40.

In certain embodiments of the subject method, the transition metal catalyst includes one or more phosphine or aminophosphine ligands, e.g., as a Lewis basic ligand that controls the stability and electron transfer properties of the transition metal catalyst, and/or stabilizes the metal intermediates. Phosphine ligands are commercially available or can be prepared by methods similar to known processes. The phosphines can be monodentate phosphine ligands, such as di-tert-butyl(2′,4′,6′-triisopropyl-3,6-dimethoxybiphenyl-2-yl)phosphine (BrettPhos), dicyclohexyl(2′,4′,6′-triisopropyl-3,6-dimethoxybiphenyl-2-yl)phosphine (tBuBrettPhos), trimethylphosphine, triethylphosphine, tripropylphosphine, triisopropylphosphine, tributylphosphine, tricyclohexylphosphine, trimethyl phosphite, triethyl phosphite, tripropyl phosphite, triisopropyl phosphite, tributyl phosphite, tricyclohexyl phosphite, triphenylphosphine, tri(o-tolyl)phosphine, and triisopropylphosphine, tricyclohexylphosphine; or a bidentate phosphine ligand such as 2,2′-bis(diphenylphosphino)-1,1′-binaphthyl (BINAP), 1,2-bis(dimethylphosphino)ethane, 1,2-bis(diethylphosphino)ethane, 1,2-bis(dipropylphosphino)-ethane, 1,2-bis(diisopropylphosphino)ethane, 1,2-bis(dibutyl-phosphino)ethane, 1,2-bis(dicyclohexylphosphino)ethane, 1,3-bis(dicyclohexyl-phosphino)propane, 1,3-bis(diiso-propylphosphino)propane, 1,4-bis(diisopropyl-phosphino)-butane and 2,4-bis(dicyclo-hexylphosphino)pentane. The aminophosphines may be monodentate, e.g., each molecule of aminophosphine donates to the catalytic metal atom only a Lewis basic nitrogen atom or a Lewis basic phosphorus atom. Alternatively, the aminophosphine may be a chelating ligand, e.g., capable of donating to the catalytic metal atom both a Lewis basic nitrogen atom and a Lewis basic phosphorus atom.

### Phase-Transfer Catalysts

Phase-transfer catalysis is a technique for enhancing the reactivity of anions which are soluble in one phase, with an organic reactant which is soluble in another phase, in a system in which the two phases are immiscible. For example, phase-transfer catalysts include ammonium or phosphonium salts, polyethylene glycols, polyethylene glycol ethers, polyethylene glycol esters and crown ethers.

In certain embodiments, the phase-transfer catalyst is a poly(ethylene) glycol (PEG), which may have one or both ends “capped” as an ether (e.g., a methyl ether) or an ester (e.g., a methyl ester). PEGs are prepared by polymerization of ethylene oxide and are commercially available over a wide range of molecular weights from 300 g/mol to 10,000,000 g/mol. A general depiction of PEG is shown below, wherein n is an integer.

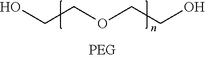

The numbers that are often included in the names of PEGs indicate their average molecular weights, e.g., a PEG with n equal to 9 would have an average molecular weight of approximately 400 daltons and would be labeled PEG 400. Most PEGs include molecules with a distribution of molecular weights, i.e., they are polydisperse. In certain embodiments, the phase-transfer catalyst is PEG 2000, Me₂PEG 2000, PEG 3400 or Me₂PEG 3400.

In certain embodiments, the phase-transfer catalyst is a crown ether. Crown ethers consist of a ring containing several ether groups. In certain embodiments, crown ethers are oligomers of ethylene oxide (i.e., with —CH₂CH₂O— as the repeating unit). In certain embodiments, the phase transfer catalyst is a crown ether is selected from the group consisting of 18-crown-6,15-crown-5 and 12-crown-4, and mixtures thereof.

### Solvent

In general, the subject reactions are carried out in a liquid reaction medium. The reactions may be run without addition of solvent. Alternatively, the reactions may be run in an inert solvent, preferably one in which the reaction ingredients, including the catalyst, are substantially soluble. Suitable solvents include ethers such as diethyl ether, 1,2-dimethoxyethane, diglyme, t-butyl methyl ether, tetrahydrofuran, water and the like; halogenated solvents such as chloroform, dichloromethane, dichloroethane, chlorobenzene, and the like; aliphatic or aromatic hydrocarbon solvents such as benzene, xylene, toluene, hexane, pentane and the like; esters and ketones such as ethyl acetate, acetone, and 2-butanone; polar aprotic solvents such as acetonitrile, dimethylformamide and the like; or combinations of two or more solvents.

The invention also contemplates reaction in a biphasic mixture of solvents, in an emulsion or suspension, or reaction in a lipid vesicle or bilayer. In certain embodiments, it may be preferred to perform the catalyzed reactions in the solid phase with one of the reactants or a ligand anchored to a solid support.

### Fluoride Source

A wide variety of fluoride sources may be used. In certain embodiments, the fluoride source is an alkali metal fluoride, an alkali earth metal fluoride or a transition metal fluoride. In certain embodiments, the fluoride source is NaF, KF, CsF, tetraalkylammonium fluoride, tetrafluoroborate (AgBF₄) or tetraalkylphosphonium fluoride.

In certain aspects of the invention, the fluoride source used in a method of the invention is [¹⁸F]fluoride source. In certain embodiments, the [¹⁸F]fluoride source is Na¹⁸F, K¹⁸F, Cs¹⁸F, tetraalkylammonium [¹⁸F]fluoride, [¹⁸F]tetrafluoroborate (AgB¹⁸F₄), or tetraalkylphosphonium [¹⁸F]fluoride.

### Exemplary Methods

The methods of the invention enable the formation of carbon-fluoride bonds via a transition metal catalyzed reaction under conditions that would not yield appreciable amounts of the observed product(s) using methods known in the art.

In one embodiment, the present invention relates to a method represented by Scheme 1:

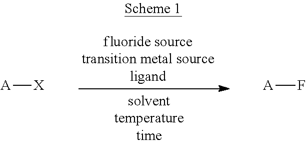

wherein, independently for each occurrence,

A is selected from the group consisting of optionally substituted aryl, optionally substituted heteroaryl and

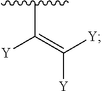

Y is hydrogen, alkyl, cycloalkyl, aryl, aralkyl, heteroaryl, or heteroaralkyl;

X is selected from the group consisting of —Cl, —Br, —I, —OS(O)₂alkyl, —OS(O)₂ perfluoroalkyl, and —OS(O)₂aryl;

the fluoride source is an alkali metal fluoride, an alkali earth metal fluoride or a transition metal fluoride;

the transition metal source comprises Ni, Pd or Pt; and

the ligand is a phosphine-containing ligand, and is achiral or, when chiral, is a single stereoisomer or a mixture of stereoisomers.

In certain embodiments, the present invention relates to any one of the aforementioned methods, wherein A is optionally substituted aryl.

In certain embodiments, the present invention relates to any one of the aforementioned methods, wherein A is an optionally substituted phenyl or optionally substituted naphthyl.

In certain embodiments, the present invention relates to any one of the aforementioned methods, wherein A is optionally substituted heteroaryl.

In certain embodiments, the present invention relates to any one of the aforementioned methods, wherein A is selected from the group consisting of

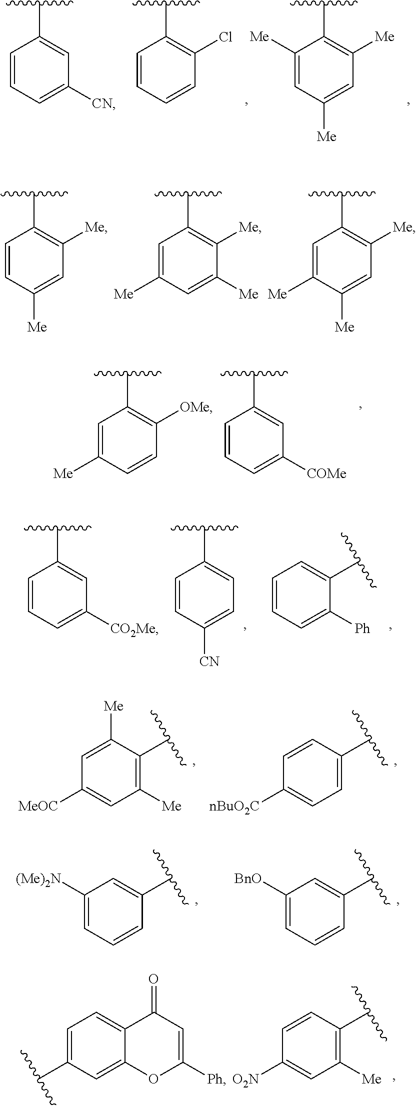

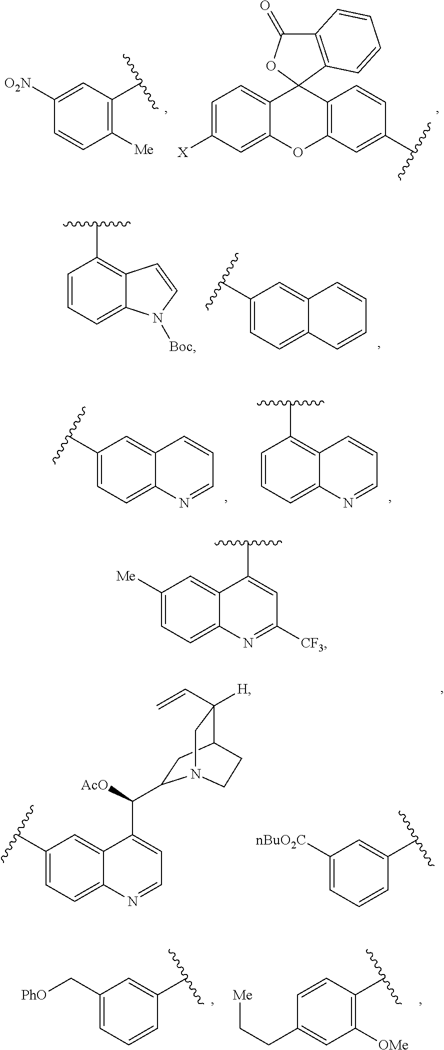

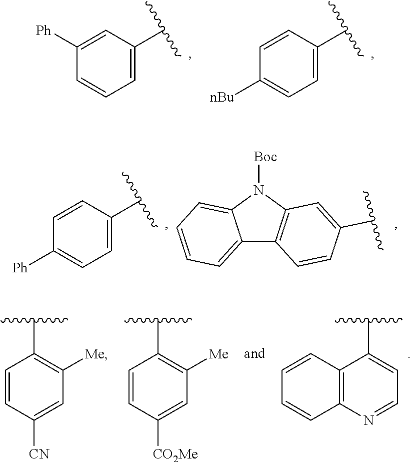

In certain embodiments, the present invention relates to any one of the aforementioned methods, wherein X is selected from the group consisting of —Cl, —Br, and —I.

In certain embodiments, the present invention relates to any one of the aforementioned methods, wherein X is —Br.

In certain embodiments, the present invention relates to any one of the aforementioned methods, wherein X is selected from the group consisting of —OS(O)₂alkyl, —OS(O)₂ perfluoroalkyl, and —OS(O)₂aryl.

In certain embodiments, the present invention relates to any one of the aforementioned methods, wherein X is —OTf.

In certain embodiments, the present invention relates to any one of the aforementioned methods, wherein the fluoride source is AgF, CsF or KF.

In certain embodiments, the present invention relates to any one of the aforementioned methods, wherein the fluoride source is CsF.

In certain embodiments, the present invention relates to any one of the aforementioned methods, wherein the fluoride source comprises ¹⁸F⁻.

In certain embodiments, the present invention relates to any one of the aforementioned methods, wherein the fluoride source is Cs¹⁸F.

In certain embodiments, the present invention relates to any one of the aforementioned methods, wherein about 1 molar equivalent of the fluoride source is used relative to the substrate.

In certain embodiments, the present invention relates to any one of the aforementioned methods, wherein about 1.5 molar equivalents of the fluoride source are used relative to the substrate.

In certain embodiments, the present invention relates to any one of the aforementioned methods, wherein about 3 molar equivalents of the fluoride source are used relative to the substrate.

In certain embodiments, the present invention relates to any one of the aforementioned methods, wherein about 4.5 molar equivalents of the fluoride source are used relative to the substrate.

In certain embodiments, the present invention relates to any one of the aforementioned methods, wherein about 6 molar equivalents of the fluoride source are used relative to the substrate.

In certain embodiments, the present invention relates to any one of the aforementioned methods, wherein the transition metal source comprises Pd.

In certain embodiments, the present invention relates to any one of the aforementioned methods, wherein the transition metal source comprises only one transition metal, which transition metal is Pd.

In certain embodiments, the present invention relates to any one of the aforementioned methods, wherein the transition metal source is selected from the group consisting of (COD)Pd(CH₂TMS)₂, Pd₂ dba₃, [allylPdCl]₂, [cinnamylPdCl]₂ and tmedaPdMe₂.

In certain embodiments, the present invention relates to any one of the aforementioned methods, wherein the ligand is a monophosphine ligand.

In certain embodiments, the present invention relates to any one of the aforementioned methods, wherein the ligand is a biphenyl-based monophosphine ligand.

In certain embodiments, the present invention relates to any one of the aforementioned methods, wherein the ligand is a ligand described in International Application No. PCT/US2008/086651, which is hereby incorporated by reference in its entirety.

In certain embodiments, the present invention relates to any one of the aforementioned methods, wherein the ligand is a biphenyl ligand as described in International Application No. PCT/US2008/086651 (see, for example, pages 19-38, which are hereby incorporated by reference).

In certain embodiments, the present invention relates to any one of the aforementioned methods, wherein the ligand an optionally-substituted biphenyl monophosphine ligand, an optionally substituted phenyl-heteroaryl monophosphine ligand, or an optionally substituted heteroaryl-heteroaryl monophosphine ligand.

In certain embodiments, the present invention relates to any one of the

aforementioned methods, wherein the ligand is represented by

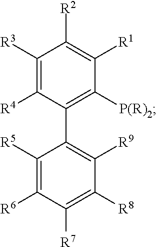

R is alkyl, adamantyl, fluoroalkyl, cycloalkyl, aryl, heteroaryl, heterocyclyl, aryloxy, or heteroaryloxy; R¹ is hydrogen, alkyl, alkoxy, fluoroalkyl, fluoroalkoxy, alkyl amino, dialkyamino, acylamino, N-lactamyl or imidyl; R² is hydrogen or alkyl; R³ is hydrogen or alkyl; R⁴ is hydrogen, alkyl, alkoxy, fluoroalkyl, fluoroalkoxy, or dialkyl amino; R⁵ and R⁶ are, independently, hydrogen, alkyl, fluoroalkyl or alkoxy, or taken together are —C(H)═C(H)—C(H)═C(H)—; R⁷ is hydrogen, alkyl, fluoroalkyl, aryl, or —C(aryl)₃; R⁸ is hydrogen, alkyl or alkoxy; and R⁹ is hydrogen or alkyl.

In certain embodiments, the present invention relates to any one of the aforementioned methods, wherein R is selected from the group consisting of cyclohexyl, t-butyl, adamantyl, trifluoromethyl, phenoxy, —C(Me)₂Et,

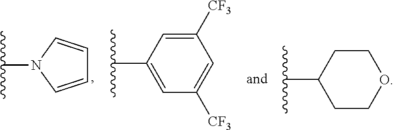

In certain embodiments, the present invention relates to any one of the aforementioned methods, wherein R is cyclohexyl.

In certain embodiments, the present invention relates to any one of the aforementioned methods, wherein R is t-butyl.

In certain embodiments, the present invention relates to any one of the aforementioned methods, wherein R¹ is methyl.

In certain embodiments, the present invention relates to any one of the aforementioned methods, wherein R¹ is methoxy.

In certain embodiments, the present invention relates to any one of the aforementioned methods, wherein R¹ is i-propyloxy.

In certain embodiments, the present invention relates to any one of the aforementioned methods, wherein R¹ is trifluoromethyl.

In certain embodiments, the present invention relates to any one of the aforementioned methods, wherein R¹ is trifluoromethoxy.

In certain embodiments, the present invention relates to any one of the aforementioned methods, wherein R¹ is dimethyl amino.

In certain embodiments, the present invention relates to any one of the aforementioned methods, wherein R² is hydrogen.

In certain embodiments, the present invention relates to any one of the aforementioned methods, wherein R² is methyl.

In certain embodiments, the present invention relates to any one of the aforementioned methods, wherein R³ is hydrogen.

In certain embodiments, the present invention relates to any one of the aforementioned methods, wherein R³ is methyl.

In certain embodiments, the present invention relates to any one of the aforementioned methods, wherein R⁴ is hydrogen.

In certain embodiments, the present invention relates to any one of the aforementioned methods, wherein R⁴ is methyl.

In certain embodiments, the present invention relates to any one of the aforementioned methods, wherein R⁴ is methoxy.

In certain embodiments, the present invention relates to any one of the aforementioned methods, wherein R¹ is hydrogen; R² is hydrogen; R³ is hydrogen; and R⁴ is hydrogen.

In certain embodiments, the present invention relates to any one of the aforementioned methods, wherein R¹ is methyl; R² is methyl; R³ is methyl; and R⁴ is methyl.

In certain embodiments, the present invention relates to any one of the aforementioned methods, wherein R¹ is methoxy; and R⁴ is methoxy.

In certain embodiments, the present invention relates to any one of the aforementioned methods, wherein R¹ is i-propyloxy; and R⁴ is methoxy.

In certain embodiments, the present invention relates to any one of the aforementioned methods, wherein R¹ is methoxy; and R⁴ is methyl.

In certain embodiments, the present invention relates to any one of the aforementioned methods, wherein R¹ is methoxy; R² is hydrogen; R³ is hydrogen; and R⁴ is methoxy.

In certain embodiments, the present invention relates to any one of the aforementioned methods, wherein R¹ is i-propyloxy; R² is hydrogen; R³ is hydrogen; and R⁴ is methoxy.

In certain embodiments, the present invention relates to any one of the aforementioned methods, wherein R¹ is methoxy; R² is hydrogen; R³ is hydrogen; and R⁴ is methyl.

In certain embodiments, the present invention relates to any one of the aforementioned methods, wherein R¹ is dimethyl amino; R² is hydrogen; R³ is hydrogen; and R⁴ is hydrogen.

In certain embodiments, the present invention relates to any one of the aforementioned methods, wherein R⁵ is hydrogen.

In certain embodiments, the present invention relates to any one of the aforementioned methods, wherein R⁵ is i-propyl.

In certain embodiments, the present invention relates to any one of the aforementioned methods, wherein R⁵ is methoxy.

In certain embodiments, the present invention relates to any one of the aforementioned methods, wherein R⁶ is hydrogen.

In certain embodiments, the present invention relates to any one of the aforementioned methods, wherein R⁶ is trifluoromethyl.

In certain embodiments, the present invention relates to any one of the aforementioned methods, wherein R⁶ is methoxy.

In certain embodiments, the present invention relates to any one of the aforementioned methods, wherein R⁵ and R⁶ taken together are —C(H)═C(H)—C(H)═C(H)—.

In certain embodiments, the present invention relates to any one of the aforementioned methods, wherein R⁷ is hydrogen.

In certain embodiments, the present invention relates to any one of the aforementioned methods, wherein R⁷ is alkyl.

In certain embodiments, the present invention relates to any one of the aforementioned methods, wherein R⁷ is i-propyl.

In certain embodiments, the present invention relates to any one of the aforementioned methods, wherein R⁷ is t-butyl.

In certain embodiments, the present invention relates to any one of the aforementioned methods, wherein R⁷ is —C(Ph)₃.

In certain embodiments, the present invention relates to any one of the aforementioned methods, wherein R⁷ is trifluoromethyl.

In certain embodiments, the present invention relates to any one of the aforementioned methods, wherein R⁷ is aryl.

In certain embodiments, the present invention relates to any one of the aforementioned methods, wherein R⁸ is hydrogen.

In certain embodiments, the present invention relates to any one of the aforementioned methods, wherein R⁸ is trifluoromethyl.

In certain embodiments, the present invention relates to any one of the aforementioned methods, wherein R⁸ is methoxy.

In certain embodiments, the present invention relates to any one of the aforementioned methods, wherein R⁹ is hydrogen.

In certain embodiments, the present invention relates to any one of the aforementioned methods, wherein R⁹ is methoxy.

In certain embodiments, the present invention relates to any one of the aforementioned methods, wherein R⁹ is i-propyl.

In certain embodiments, the present invention relates to any one of the aforementioned methods, wherein R⁵ is i-propyl; and R⁹ is i-propyl.

In certain embodiments, the present invention relates to any one of the aforementioned methods, wherein R⁵ is i-propyl; R⁷ is t-butyl; and R⁹ is i-propyl.

In certain embodiments, the present invention relates to any one of the aforementioned methods, wherein R⁵ is i-propyl; R⁷ is trifluoromethyl; and R⁹ is i-propyl.

In certain embodiments, the present invention relates to any one of the aforementioned methods, wherein R⁵ is i-propyl; R⁷ is i-propyl; and R⁹ is i-propyl.

In certain embodiments, the present invention relates to any one of the aforementioned methods, wherein R⁵ is i-propyl; R⁶ is hydrogen; R⁷ is trifluoromethyl; R⁸ is hydrogen; and R⁹ is i-propyl.

In certain embodiments, the present invention relates to any one of the aforementioned methods, wherein R⁵ is i-propyl; R⁶ is hydrogen; R⁷ is t-butyl; R⁸ is hydrogen; and R⁹ is i-propyl.

In certain embodiments, the present invention relates to any one of the aforementioned methods, wherein R⁵ is i-propyl; R⁶ is hydrogen; R⁷ is i-propyl; R⁸ is hydrogen; and R⁹ is i-propyl.

In certain embodiments, the present invention relates to any one of the aforementioned methods, wherein R⁶ is methoxy; and R⁸ is methoxy.

In certain embodiments, the present invention relates to any one of the aforementioned methods, wherein R⁶ is trifluoromethyl; and R⁸ is trifluoromethyl.

In certain embodiments, the present invention relates to any one of the aforementioned methods, wherein R⁵ is hydrogen; R⁶ is methoxy; R⁷ is hydrogen; R⁸ is methoxy; and R⁹ is hydrogen.

In certain embodiments, the present invention relates to any one of the aforementioned methods, wherein R⁵ is hydrogen; R⁶ is trifluoromethyl; R⁷ is hydrogen; R⁸ is trifluoromethyl; and R⁹ is hydrogen.

In certain embodiments, the present invention relates to any one of the aforementioned methods, wherein the ligand is selected from the group consisting of

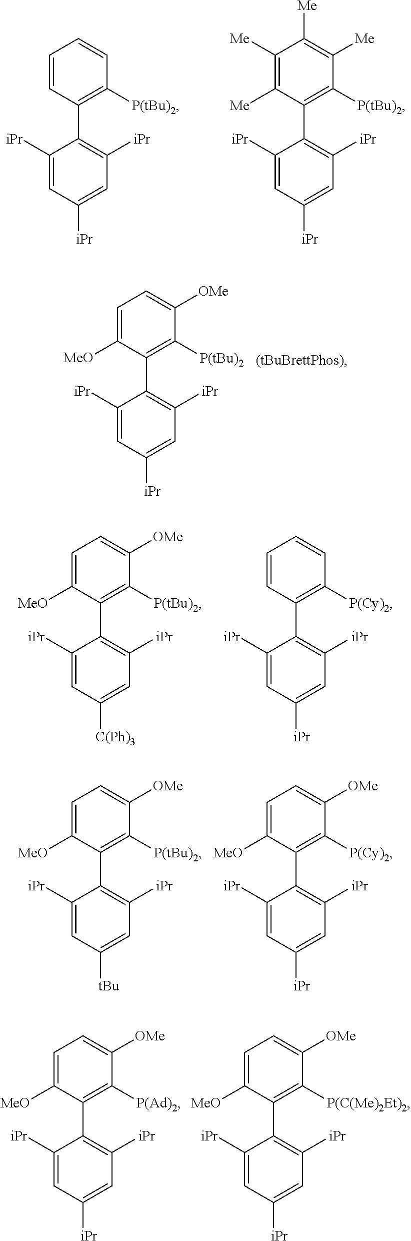

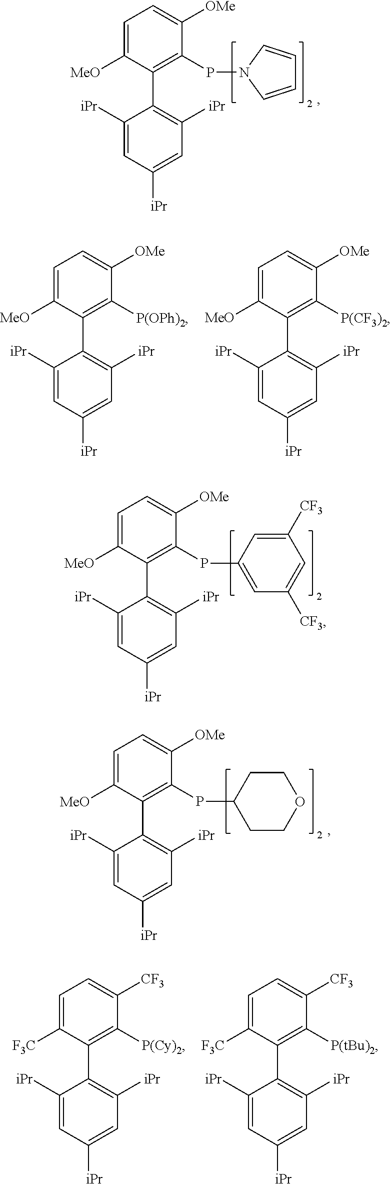

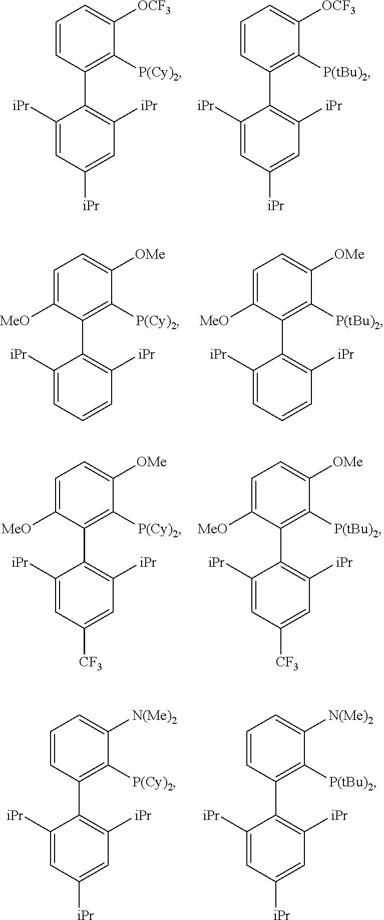

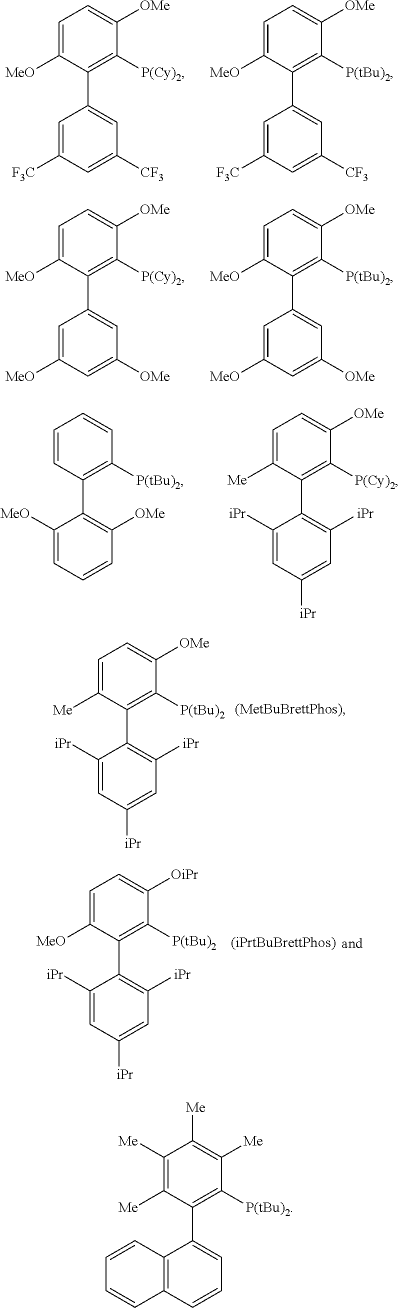

In certain embodiments, the present invention relates to any one of the aforementioned methods, wherein the ligand is tBuBrettPhos.

In certain embodiments, the present invention relates to any one of the aforementioned methods, wherein the ligand is

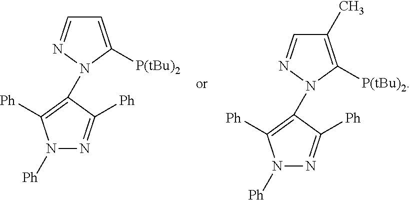

In certain embodiments, the present invention relates to any one of the aforementioned methods, wherein the molar ratio of ligand to transition metal source is about 2:1.

In certain embodiments, the present invention relates to any one of the aforementioned methods, wherein the molar ratio of ligand to transition metal source is about 1.5:1.

In certain embodiments, the present invention relates to any one of the aforementioned methods, wherein the molar ratio of ligand to transition metal source is about 1:1.

In certain embodiments, the present invention relates to any one of the aforementioned methods, wherein the Ni, Pd or Pt is present in between about 2 mol % and about 10 mol % relative to the substrate.

In certain embodiments, the present invention relates to any one of the aforementioned methods, wherein the temperature is between about 25° C. and about 200° C.

In certain embodiments, the present invention relates to any one of the aforementioned methods, wherein the temperature is between about 70° C. and about ° C.

In certain embodiments, the present invention relates to any one of the aforementioned methods, wherein the temperature is about 100° C.

In certain embodiments, the present invention relates to any one of the aforementioned methods, wherein the temperature is about 130° C.

In certain embodiments, the present invention relates to any one of the aforementioned methods, wherein the solvent is toluene, benzene, dibutyl ether, THF, cyclohexane, n-heptane, 1,4-dioxane, DME, α,α,α-trifluorotoluene, DMF, or a mixture thereof.

In certain embodiments, the present invention relates to any one of the aforementioned methods, wherein the solvent is toluene.

In certain embodiments, the present invention relates to any one of the aforementioned methods, wherein the solvent is cyclohexane.

In certain embodiments, the present invention relates to any one of the aforementioned methods, wherein the time is less than about 48 hours.

In certain embodiments, the present invention relates to any one of the aforementioned methods, wherein the time is less than about 24 hours.

In certain embodiments, the present invention relates to any one of the aforementioned methods, wherein the time is less than about 12 hours.

In certain embodiments, the present invention relates to any one of the aforementioned methods, wherein the time is less than about 6 hours.

In certain embodiments, the present invention relates to any one of the aforementioned methods, wherein the time is less than about 3 hours.

In certain embodiments, the present invention relates to any one of the aforementioned methods, wherein the time is less than about 1.5 hours.

In certain embodiments, the present invention relates to any one of the aforementioned methods, further comprising a solubilizing additive.

In certain embodiments, the present invention relates to any one of the aforementioned methods, wherein the solubilizing additive is PEG wherein one or both ends of the PEG may be capped as alkyl ethers.

In certain embodiments, the present invention relates to any one of the aforementioned methods, wherein the solubilizing additive is PEG 2000, Me₂PEG 2000, PEG 3400 or Me₂PEG 3400.

In certain embodiments, the present invention relates to any one of the aforementioned methods, wherein the reaction is done under anhydrous conditions.

In certain embodiments of the reactions of the invention, use of a large excess of substrate, e.g., aryl bromide, heteroaryl triflate, vinyl bromide and the like, results in an increased yield.

The reactions typically proceed at mild temperatures and pressures to give high yields of the product aryl fluoride, heteroaryl fluoride, or vinyl fluoride. Thus, yields of desired products greater than 45%, greater than 75%, and greater than 80% may be obtained from reactions at mild temperatures according to the invention.

In certain embodiments it is preferable to perform the reactions under an inert atmosphere of a gas such as nitrogen or argon.

In certain embodiments it is preferable to perform the reactions under microwave irradiation. The term “microwave” refers to that portion of the electromagnetic spectrum between about 300 and 300,000 megahertz (MHz) with wavelengths of between about one millimeter (1 mm) and one meter (1 m). These are, of course, arbitrary boundaries, but help quantify microwaves as falling below the frequencies of infrared radiation but above those referred to as radio frequencies. Similarly, given the well-established inverse relationship between frequency and wavelength, microwaves have longer wavelengths than infrared radiation, but shorter than radio frequency wavelengths. Microwave-assisted chemistry techniques are generally well established in the academic and commercial arenas. Microwaves have some significant advantages in heating certain substances. In particular, when microwaves interact with substances with which they can couple, most typically polar molecules or ionic species, the microwaves can immediately create a large amount of kinetic energy in such species which provides sufficient energy to initiate or accelerate various chemical reactions. Microwaves also have an advantage over conduction heating in that the surroundings do not need to be heated because the microwaves can react instantaneously with the desired species.

The reaction processes of the present invention can be conducted in continuous, semi-continuous or batch fashion and may involve a liquid recycle operation as desired. The processes of this invention are preferably conducted in batch fashion. Likewise, the manner or order of addition of the reaction ingredients, catalyst and solvent are also not generally critical to the success of the reaction, and may be accomplished in any conventional fashion.

The reaction can be conducted in a single reaction zone or in a plurality of reaction zones, in series or in parallel or it may be conducted batchwise or continuously in an elongated tubular zone or series of such zones. The materials of construction employed should be inert to the starting materials during the reaction and the fabrication of the equipment should be able to withstand the reaction temperatures and pressures. Means to introduce and/or adjust the quantity of starting materials or ingredients introduced batchwise or continuously into the reaction zone during the course of the reaction can be conveniently utilized in the processes especially to maintain the desired molar ratio of the starting materials. The reaction steps may be effected by the incremental addition of one of the starting materials to the other. Also, the reaction steps can be combined by the joint addition of the starting materials to the metal catalyst. When complete conversion is not desired or not obtainable, the starting materials can be separated from the product and then recycled back into the reaction zone.

The processes may be conducted in either glass lined, stainless steel, fluoropolymer coated (e.g., Teflon coated) or similar type reaction equipment. The reaction zone may be fitted with one or more internal and/or external heat exchanger(s) in order to control undue temperature fluctuations, or to prevent any possible “runaway” reaction temperatures.

Furthermore, one or more of the reactants can be immobilized on or incorporated into a polymer or other insoluble matrix by, for example, derivatization with one or more of the substituents of the aryl group.

The ability to provide synthesis schemes for aryl fluorides, heteroaryl fluorides, and vinyl fluorides, which can be carried out under mild conditions has broad application, especially in the agricultural and pharmaceutical industries, as well as in the polymer industry. In this regard, the subject reactions are particularly well-suited to reactants or products which include sensitive functionalities, e.g., which would otherwise be labile under harsh reaction conditions. When radioactive fluorine sources are used, PET imaging agents can be prepared.

In addition, the subject fluorination can be used as part of combinatorial synthesis schemes to yield libraries of aryl fluorides, heteroaryl fluorides and/or vinyl fluorides. Accordingly, another aspect of the present invention relates to use of the subject method to generate variegated libraries of aryl fluorides, heteroaryl fluorides and/or vinyl fluorides, and to the libraries themselves. The libraries can be soluble or linked to insoluble supports, e.g., through a substituent of a reactant (prior to carrying out a reaction of the present invention), e.g., the aryl group, heteroaryl group or vinyl group.

Further, the methods of the invention can be used to produce synthetic intermediates that, after being subjected to additional methods known in the art, are transformed to desired end products, e.g., lead compounds in medicinal chemistry programs, pharmaceuticals, insecticides, antivirals and antifungals.

### DEFINITIONS

For convenience, certain terms employed in the specification, examples, and appended claims are collected here.

The articles “a” and “an” are used herein to refer to one or to more than one (i.e., to at least one) of the grammatical object of the article. By way of example, “an element” means one element or more than one element.

The term “substrate aryl group”, “substrate heteroaryl group” or “substrate vinyl group” refers to such groups containing an electrophilic atom which is susceptible to the subject fluorination reaction, e.g., the electrophilic atom bears a leaving group. In reaction scheme 1, the substrate is represented by A-X, and X is the leaving group. The aryl, heteroaryl or vinyl group, A, is said to be substituted if, in addition to X, it is substituted at yet other positions. In certain embodiments, the substrate aryl, heteroaryl or vinyl groups are a component of a larger molecule.

The term “nucleophile” is recognized in the art, and as used herein means a chemical moiety having a reactive pair of electrons.

The term “electrophile” is art-recognized and refers to chemical moieties which can accept a pair of electrons from a nucleophile as defined herein. Electrophilic moieties useful in the method of the present invention include halides and sulfonates.

The terms “electrophilic atom,” “electrophilic center” and “reactive center” as used herein refer to the atom of the substrate aryl moiety which is attacked by, and forms a new bond to the nucleophilic heteroatom of the hydrazine and the like. In most (but not all) cases, this will also be the aryl ring atom from which the leaving group departs.

The term “electron-withdrawing group” is recognized in the art, and denotes the tendency of a substituent to attract valence electrons from neighboring atoms, i.e., the substituent is electronegative with respect to neighboring atoms. A quantification of the level of electron-withdrawing capability is given by the Hammett sigma (s) constant. This well known constant is described in many references, for instance, J. March, Advanced Organic Chemistry, McGraw Hill Book Company, New York, (1977 edition) pp. 251-259. The Hammett constant values are generally negative for electron donating groups (s[P]=−0.66 for NH₂) and positive for electron withdrawing groups (s[P]=0.78 for a nitro group), s[P] indicating para substitution. Exemplary electron-withdrawing groups include nitro, ketone, aldehyde, sulfonyl, trifluoromethyl, cyano, chloride, and the like. Exemplary electron-donating groups include amino, methoxy, and the like.

The term “reaction product” means a compound which results from the reaction of the fluoride source and the substrate. In general, the term “reaction product” will be used herein to refer to a fluorinated aryl, heteroaryl or vinyl group.

The term “catalytic amount” is recognized in the art and means a substoichiometric amount of reagent relative to a reactant. As used herein, a catalytic amount means from 0.0001 to 90 mole percent reagent relative to a reactant, more preferably from 0.001 to 50 mole percent, still more preferably from 0.01 to 10 mole percent, and even more preferably from 0.1 to 5 mole percent reagent to reactant.

The term “heteroatom” is art-recognized and refers to an atom of any element other than carbon or hydrogen. Illustrative heteroatoms include boron, nitrogen, oxygen, phosphorus, sulfur and selenium.

The term “alkenyl” as used herein, means a straight or branched chain hydrocarbon containing from 2 to 10 carbons and containing at least one carbon-carbon double bond formed by the removal of two hydrogens. Representative examples of alkenyl include, but are not limited to, ethenyl, 2-propenyl, 2-methyl-2-propenyl, 3-butenyl, 4-pentenyl, 5-hexenyl, 2-heptenyl, 2-methyl-1-heptenyl, and 3-decenyl.

The term “alkoxy” means an alkyl group, as defined herein, appended to the parent molecular moiety through an oxygen atom. Representative examples of alkoxy include, but are not limited to, methoxy, ethoxy, propoxy, 2-propoxy, butoxy, tert-butoxy, pentyloxy, and hexyloxy.

The term “alkoxycarbonyl” means an alkoxy group, as defined herein, appended to the parent molecular moiety through a carbonyl group, represented by —C(═O)—, as defined herein. Representative examples of alkoxycarbonyl include, but are not limited to, methoxycarbonyl, ethoxycarbonyl, and tert-butoxycarbonyl.

The term “alkoxysulfonyl” as used herein, means an alkoxy group, as defined herein, appended to the parent molecular moiety through a sulfonyl group, as defined herein. Representative examples of alkoxysulfonyl include, but are not limited to, methoxysulfonyl, ethoxysulfonyl and propoxysulfonyl.

The term “arylalkoxy” and “heteroalkoxy” as used herein, means an aryl group or heteroaryl group, as defined herein, appended to the parent molecular moiety through an alkoxy group, as defined herein. Representative examples of arylalkoxy include, but are not limited to, 2-chlorophenylmethoxy, 3-trifluoromethylethoxy, and 2,3-methylmethoxy.

The term “arylalkyl” as used herein, means an aryl group, as defined herein, appended to the parent molecular moiety through an alkyl group, as defined herein. Representative examples of alkoxyalkyl include, but are not limited to, tert-butoxymethyl, 2-ethoxyethyl, 2-methoxyethyl, and methoxymethyl.

The term “alkyl” means a straight or branched chain hydrocarbon containing from 1 to 10 carbon atoms. Representative examples of alkyl include, but are not limited to, methyl, ethyl, n-propyl, iso-propyl, n-butyl, sec-butyl, iso-butyl, tert-butyl, n-pentyl, isopentyl, neopentyl, and n-hexyl.

The term “alkylcarbonyl” as used herein, means an alkyl group, as defined herein, appended to the parent molecular moiety through a carbonyl group, as defined herein. Representative examples of alkylcarbonyl include, but are not limited to, acetyl, 1-oxopropyl, 2,2-dimethyl-1-oxopropyl, 1-oxobutyl, and 1-oxopentyl.

The term “alkylcarbonyloxy” and “arylcarbonyloxy” as used herein, means an alkylcarbonyl or arylcarbonyl group, as defined herein, appended to the parent molecular moiety through an oxygen atom. Representative examples of alkylcarbonyloxy include, but are not limited to, acetyloxy, ethylcarbonyloxy, and tert-butylcarbonyloxy.

Representative examples of arylcarbonyloxy include, but are not limited to phenylcarbonyloxy.

The term “alkylsulfonyl” as used herein, means an alkyl group, as defined herein, appended to the parent molecular moiety through a sulfonyl group, as defined herein. Representative examples of alkylsulfonyl include, but are not limited to, methylsulfonyl and ethylsulfonyl.

The term “alkylthio” as used herein, means an alkyl group, as defined herein, appended to the parent molecular moiety through a sulfur atom. Representative examples of alkylthio include, but are not limited, methylthio, ethylthio, tert-butylthio, and hexylthio. The terms “arylthio,” “alkenylthio” and “arylakylthio,” for example, are likewise defined.

The term “alkynyl” as used herein, means a straight or branched chain hydrocarbon group containing from 2 to 10 carbon atoms and containing at least one carbon-carbon triple bond. Representative examples of alkynyl include, but are not limited, to acetylenyl, 1-propynyl, 2-propynyl, 3-butynyl, 2-pentynyl, and 1-butynyl.

The term “amido” as used herein, means —NHC(═O)—, wherein the amido group is bound to the parent molecular moiety through the nitrogen. Examples of amido include alkylamido such as CH₃C(═O)N(H)— and CH₃CH₂C(═O)N(H)—.

The term “amino” as used herein, refers to radicals of both unsubstituted and substituted amines appended to the parent molecular moiety through a nitrogen atom. The two groups are each independently hydrogen, alkyl, alkylcarbonyl, alkylsulfonyl, arylcarbonyl, or formyl. Representative examples include, but are not limited to methylamino, acetylamino, and acetylmethylamino.

The term “aromatic” refers to a planar or polycyclic structure characterized by a cyclically conjugated molecular moiety containing 4n+2 electrons, wherein n is the absolute value of an integer. Aromatic molecules containing fused, or joined, rings also are referred to as bicyclic aromatic rings. For example, bicyclic aromatic rings containing heteroatoms in a hydrocarbon ring structure are referred to as bicyclic heteroaryl rings.

The term “aryl,” as used herein, means a phenyl group or a naphthyl group. The aryl groups of the present invention can be optionally substituted with 1, 2, 3, 4 or 5 substituents independently selected from the group consisting of alkenyl, alkoxy, alkoxycarbonyl, alkoxysulfonyl, alkyl, alkylcarbonyl, alkylcarbonyloxy, alkylsulfonyl, alkylthio, alkynyl, amido, amino, carboxy, cyano, formyl, halo, haloalkoxy, haloalkyl, hydroxyl, hydroxyalkyl, mercapto, nitro, phosphinyl, silyl and silyloxy.

The term “arylene,” is art-recognized, and as used herein, pertains to a bidentate moiety obtained by removing two hydrogen atoms of an aryl ring, as defined above.

The term “arylalkyl” or “aralkyl” as used herein, means an aryl group, as defined herein, appended to the parent molecular moiety through an alkyl group, as defined herein. Representative examples of arylalkyl include, but are not limited to, benzyl, 2-phenylethyl, 3-phenylpropyl, and 2-naphth-2-ylethyl.

The term “arylalkoxy” or “arylalkyloxy” as used herein, means an arylalkyl group, as defined herein, appended to the parent molecular moiety through an oxygen. The term “heteroarylalkoxy” as used herein, means an heteroarylalkyl group, as defined herein, appended to the parent molecular moiety through an oxygen.

The term “arylalkylthio” as used herein, means an arylalkyl group, as defined herein, appended to the parent molecular moiety through an sulfur. The term “heteroarylalkylthio” as used herein, means an heteroarylalkyl group, as defined herein, appended to the parent molecular moiety through an sulfur.

The term “arylalkenyl” as used herein, means an aryl group, as defined herein, appended to the parent molecular moiety through an alkenyl group. A representative example is phenylethylenyl.

The term “arylalkynyl” as used herein, means an aryl group, as defined herein, appended to the parent molecular moiety through an alkynyl group. A representative example is phenylethynyl.

The term “arylcarbonyl” as used herein, means an aryl group, as defined herein, appended to the parent molecular moiety through a carbonyl group, as defined herein. Representative examples of arylcarbonyl include, but are not limited to, benzoyl and naphthoyl.

The term “arylcarbonylalkyl” as used herein, means an arylcarbonyl group, as defined herein, bound to the parent molecule through an alkyl group, as defined herein.

The term “arylcarbonylalkoxy” as used herein, means an arylcarbonylalkyl group, as defined herein, bound to the parent molecule through an oxygen.

The term “aryloxy” as used herein, means an aryl group, as defined herein, appended to the parent molecular moiety through an oxygen. The term “heteroaryloxy” as used herein, means a heteroaryl group, as defined herein, appended to the parent molecular moiety through an oxygen.

The terms “biphenyl” and “binaphthylene” refer to the ring systems below. The numbers around the peripheries of the ring systems are the positional numbering systems used herein. Likewise, the capital letters contained within the individual rings of the ring systems are the ring descriptors used herein.

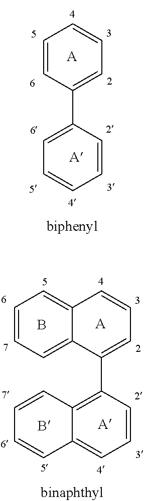

Any position on the biphenyl or binaphthyl may be substituted with a substituent independently selected from the group consisting of alkenyl, alkoxy, alkoxycarbonyl, alkoxysulfonyl, alkyl, alkylcarbonyl, alkylcarbonyloxy, alkylsulfonyl, alkylthio, alkynyl, amido, amino, carboxy, cyano, formyl, halo, haloalkoxy, haloalkyl, hydroxyl, hydroxyalkyl, mercapto, nitro, phosphinyl, silyl and silyloxy.

The term “phenyl-heteroaryl” and “heteroaryl-heteroaryl” refer to ring systems similar to those shown above for biphenyl, wherein one of the phenyl rings is replaced with an heteroaryl ring, as defined below. Any position on the phenyl-heteroaryl or heteroaryl-heteroaryl may be substituted with a substituent independently selected from the group consisting of alkenyl, alkoxy, alkoxycarbonyl, alkoxysulfonyl, alkyl, alkylcarbonyl, alkylcarbonyloxy, alkylsulfonyl, alkylthio, alkynyl, amido, amino, carboxy, cyano, formyl, halo, haloalkoxy, haloalkyl, hydroxyl, hydroxyalkyl, mercapto, nitro, phosphinyl, silyl and silyloxy.

The term “carbonyl” as used herein, means a —C(═O)— group.

The term “carboxy” as used herein, means a —CO₂H group.

The term “cycloalkyl” as used herein, means monocyclic or multicyclic (e.g., bicyclic, tricyclic, etc.) hydrocarbons containing from 3 to 12 carbon atoms that is completely saturated or has one or more unsaturated bonds but does not amount to an aromatic group. Examples of a cycloalkyl group include cyclopropyl, cyclobutyl, cyclopentyl, cyclopentenyl, cyclohexyl and cyclohexenyl.

The term “cycloalkoxy” as used herein, means a cycloalkyl group, as defined herein, appended to the parent molecular moiety through an oxygen.

The term “cyano” as used herein, means a —CN group.

The term “formyl” as used herein, means a —C(═O)H group.

The term “halo” or “halogen” means —Cl, —Br, —I or —F.

The term “haloalkoxy” as used herein, means at least one halogen, as defined herein, appended to the parent molecular moiety through an alkoxy group, as defined herein. Representative examples of haloalkoxy include, but are not limited to, chloromethoxy, 2-fluoroethoxy, trifluoromethoxy, and pentafluoroethoxy.

The term “haloalkyl” means at least one halogen, as defined herein, appended to the parent molecular moiety through an alkyl group, as defined herein. Representative examples of haloalkyl include, but are not limited to, chloromethyl, 2-fluoroethyl, trifluoromethyl, pentafluoroethyl, and 2-chloro-3-fluoropentyl.

The term “heterocyclyl”, as used herein, include non-aromatic, ring systems, including, but not limited to, monocyclic, bicyclic and tricyclic rings, which can be completely saturated or which can contain one or more units of unsaturation, for the avoidance of doubt, the degree of unsaturation does not result in an aromatic ring system) and have 3 to 12 atoms including at least one heteroatom, such as nitrogen, oxygen, or sulfur. For purposes of exemplification, which should not be construed as limiting the scope of this invention, the following are examples of heterocyclic rings: azepines, azetidinyl, morpholinyl, oxopiperidinyl, oxopyrrolidinyl, piperazinyl, piperidinyl, pyrrolidinyl, quinicludinyl, thiomorpholinyl, tetrahydropyranyl and tetrahydrofuranyl. The heterocyclyl groups of the invention are substituted with 0, 1, 2, 3, 4 or 5 substituents independently selected from alkenyl, alkoxy, alkoxycarbonyl, alkoxysulfonyl, alkyl, alkylcarbonyl, alkylcarbonyloxy, alkylsulfonyl, alkylthio, alkynyl, amido, amino, carboxy, cyano, formyl, halo, haloalkoxy, haloalkyl, hydroxyl, hydroxyalkyl, mercapto, nitro, phosphinyl, silyl and silyloxy.

The term “heteroaryl” as used herein, include aromatic ring systems, including, but not limited to, monocyclic, bicyclic and tricyclic rings, and have 3 to 12 atoms including at least one heteroatom, such as nitrogen, oxygen, or sulfur. For purposes of exemplification, which should not be construed as limiting the scope of this invention: azaindolyl, benzo(b)thienyl, benzimidazolyl, benzofuranyl, benzoxazolyl, benzothiazolyl, benzothiadiazolyl, benzotriazolyl, benzoxadiazolyl, furanyl, imidazolyl, imidazopyridinyl, indolyl, indolinyl, indazolyl, isoindolinyl, isoxazolyl, isothiazolyl, isoquinolinyl, oxadiazolyl, oxazolyl, purinyl, pyranyl, pyrazinyl, pyrazolyl, pyridinyl, pyrimidinyl, pyrrolyl, pyrrolo[2,3-d]pyrimidinyl, pyrazolo[3,4-d]pyrimidinyl, quinolinyl, quinazolinyl, triazolyl, thiazolyl, thiophenyl, tetrahydroindolyl, tetrazolyl, thiadiazolyl, thienyl, thiomorpholinyl, triazolyl or tropanyl. The heteroaryl groups of the invention are substituted with 0, 1, 2, 3, 4 or 5 substituents independently selected from alkenyl, alkoxy, alkoxycarbonyl, alkoxysulfonyl, alkyl, alkylcarbonyl, alkylcarbonyloxy, alkylsulfonyl, alkylthio, alkynyl, amido, amino, carboxy, cyano, formyl, halo, haloalkoxy, haloalkyl, hydroxyl, hydroxyalkyl, mercapto, nitro, phosphinyl, silyl and silyloxy.

The term “heteroarylene,” is art-recognized, and as used herein, pertains to a bidentate moiety obtained by removing two hydrogen atoms of a heteroaryl ring, as defined above.

The term “heteroarylalkyl” or “heteroaralkyl” as used herein, means a heteroaryl, as defined herein, appended to the parent molecular moiety through an alkyl group, as defined herein. Representative examples of heteroarylalkyl include, but are not limited to, pyridin-3-ylmethyl and 2-(thien-2-yl)ethyl.

The term “hydroxy” as used herein, means an —OH group.

The term “hydroxyalkyl” as used herein, means at least one hydroxy group, as defined herein, is appended to the parent molecular moiety through an alkyl group, as defined herein. Representative examples of hydroxyalkyl include, but are not limited to, hydroxymethyl, 2-hydroxyethyl, 3-hydroxypropyl, 2,3-dihydroxypentyl, and 2-ethyl-4-hydroxyheptyl.

The term “mercapto” as used herein, means a —SH group.

The term “nitro” as used herein, means a —NO₂ group.

The term “phosphinyl” as used herein includes derivatives of the H₃P— group, wherein the hydrogens are independently replaced with alkyl, adamantyl, fluoroalkyl, cycloalkyl, aryl, heteroaryl, heterocyclyl, aryloxy, or heteroaryloxy groups.

The term “silyl” as used herein includes hydrocarbyl derivatives of the silyl (H₃Si—) group (i.e., (hydrocarbyl)₃Si—), wherein a hydrocarbyl groups are univalent groups formed by removing a hydrogen atom from a hydrocarbon, e.g., ethyl, phenyl. The hydrocarbyl groups can be combinations of differing groups which can be varied in order to provide a number of silyl groups, such as trimethylsilyl (TMS), tert-butyldiphenylsilyl (TBDPS), tert-butyldimethylsilyl (TBS/TBDMS), triisopropylsilyl (TIPS), and [2-(trimethylsilyl)ethoxy]methyl (SEM).

The term “silyloxy” as used herein means a silyl group, as defined herein, is appended to the parent molecule through an oxygen atom.

The definition of each expression, e.g., alkyl, m, n, and the like, when it occurs more than once in any structure, is intended to be independent of its definition elsewhere in the same structure.

The terms triflyl, tosyl, mesyl, and nonaflyl are art-recognized and refer to trifluoromethanesulfonyl, p-toluenesulfonyl, methanesulfonyl, and nonafluorobutanesulfonyl groups, respectively. The terms triflate, tosylate, mesylate, and nonaflate are art-recognized and refer to trifluoromethanesulfonate ester, p-toluenesulfonate ester, methanesulfonate ester, and nonafluorobutanesulfonate ester functional groups and molecules that contain said groups, respectively.

The abbreviations Me, Et, Ph, Tf, Nf, Ts, and Ms represent methyl, ethyl, phenyl, trifluoromethanesulfonyl, nonafluorobutanesulfonyl, p-toluenesulfonyl and methanesulfonyl, respectively. A more comprehensive list of the abbreviations utilized by organic chemists of ordinary skill in the art appears in the first issue of each volume of the Journal of Organic Chemistry; this list is typically presented in a table entitled Standard List of Abbreviations.

Certain compounds contained in compositions of the present invention may exist in particular geometric or stereoisomeric forms. In addition, polymers of the present invention may also be optically active. The present invention contemplates all such compounds, including cis- and trans-isomers, R- and S-enantiomers, diastereomers, (D)-isomers, (L)-isomers, the racemic mixtures thereof, and other mixtures thereof, as falling within the scope of the invention. Additional asymmetric carbon atoms may be present in a substituent such as an alkyl group. All such isomers, as well as mixtures thereof, are intended to be included in this invention.

If, for instance, a particular enantiomer of compound of the present invention is desired, it may be prepared by asymmetric synthesis, or by derivation with a chiral auxiliary, where the resulting diastereomeric mixture is separated and the auxiliary group cleaved to provide the pure desired enantiomers. Alternatively, where the molecule contains a basic functional group, such as amino, or an acidic functional group, such as carboxyl, diastereomeric salts are formed with an appropriate optically-active acid or base, followed by resolution of the diastereomers thus formed by fractional crystallization or chromatographic means well known in the art, and subsequent recovery of the pure enantiomers.

It will be understood that “substitution” or “substituted with” includes the implicit proviso that such substitution is in accordance with permitted valence of the substituted atom and the substituent, and that the substitution results in a stable compound, e.g., which does not spontaneously undergo transformation such as by rearrangement, cyclization, elimination, or other reaction.

The term “substituted” is also contemplated to include all permissible substituents of organic compounds. In a broad aspect, the permissible substituents include acyclic and cyclic, branched and unbranched, carbocyclic and heterocyclic, aromatic and nonaromatic substituents of organic compounds. Illustrative substituents include, for example, those described herein above. The permissible substituents may be one or more and the same or different for appropriate organic compounds. For purposes of this invention, the heteroatoms such as nitrogen may have hydrogen substituents and/or any permissible substituents of organic compounds described herein which satisfy the valences of the heteroatoms. This invention is not intended to be limited in any manner by the permissible substituents of organic compounds.

The phrase “protecting group” as used herein means temporary substituents which protect a potentially reactive functional group from undesired chemical transformations. Examples of such protecting groups include esters of carboxylic acids, silyl ethers of alcohols, and acetals and ketals of aldehydes and ketones, respectively. The field of protecting group chemistry has been reviewed (Greene, T. W.; Wuts, P. G. M. Protective Groups in Organic Synthesis, 2^{nd} ed.; Wiley: New York, 1991). Protected forms of the inventive compounds are included within the scope of this invention.

A “polar solvent” means a solvent which has a dielectric constant (∈) of 2.9 or greater, such as DMF, THF, ethylene glycol dimethyl ether (DME), DMSO, acetone, acetonitrile, methanol, ethanol, isopropanol, n-propanol, t-butanol or 2-methoxyethyl ether. Preferred polar solvents are DMF, DME, NMP, and acetonitrile.

An “aprotic solvent” means a non-nucleophilic solvent having a boiling point range above ambient temperature, preferably from about 25° C. to about 190° C., more preferably from about 80° C. to about 160° C., most preferably from about 80° C. to 150° C., at atmospheric pressure. Examples of such solvents are acetonitrile, toluene, DMF, diglyme, THF or DMSO.

A “polar, aprotic solvent” means a polar solvent as defined above which has no available hydrogens to exchange with the compounds of this invention during reaction, for example DMF, acetonitrile, diglyme, DMSO, or THF.

A “hydroxylic solvent” means a solvent that comprises a hydroxyl moiety; for example, water, methanol, ethanol, tent-butanol, and ethylene glycol are hydroxylic solvents.

For purposes of this invention, the chemical elements are identified in accordance with the Periodic Table of the Elements, CAS version, Handbook of Chemistry and Physics, 67th Ed., 1986-87, inside cover.

### EXEMPLIFICATION

The invention now being generally described, it will be more readily understood by reference to the following examples, which are included merely for purposes of illustration of certain aspects and embodiments of the present invention, and are not intended to limit the invention.

### Example 1

### Synthesis of Fluoroarenes from Bromoarenes, Chloroarenes and Iodoarenes

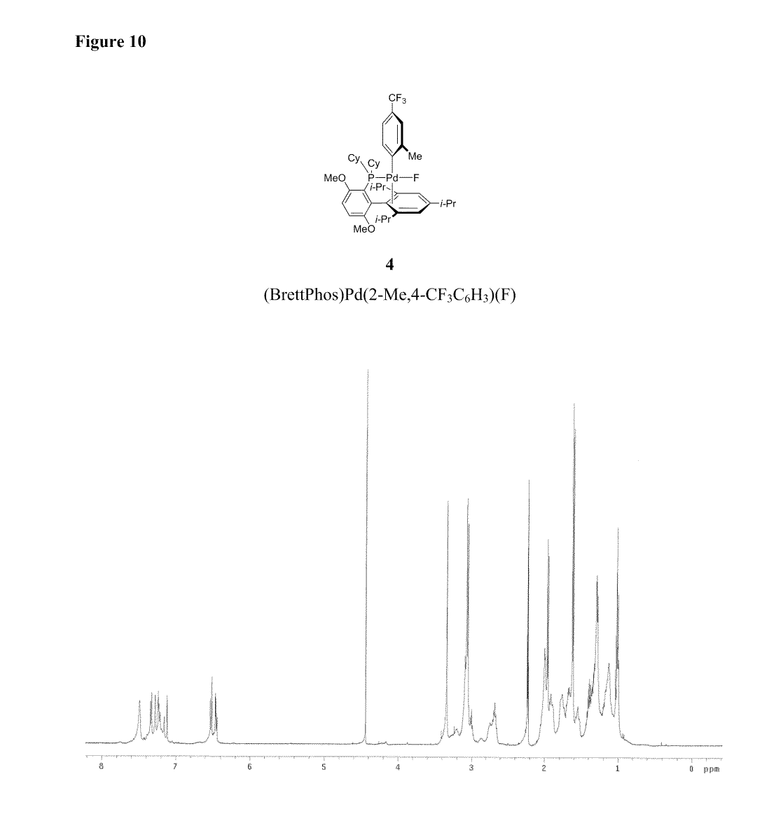

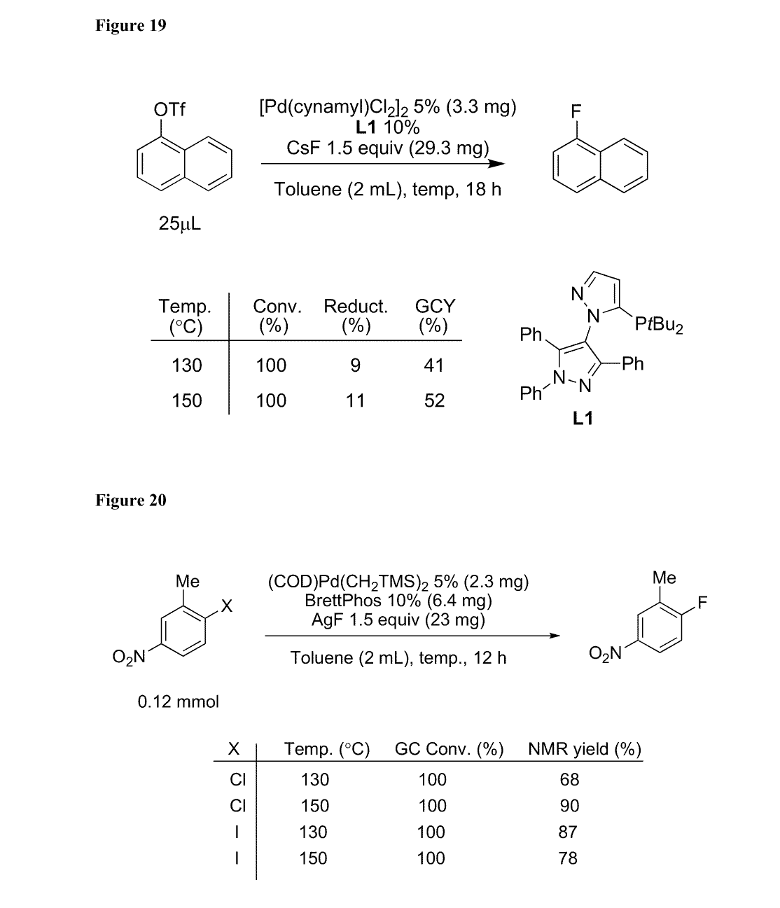

The following reactions are depicted in FIG. 8 (top) and FIG. 20.

4-Fluoro-3-methylbenzonitrile (7). To an oven-dried resealable tube equipped with a stir bar was added 4-bromo-3-methylbenzonitrile 8 (23.3 mg, 0.12 mmol), BrettPhos (6.4 mg, 0.012 mmol, 10 mol %), (COD)Pd(CH₂TMS)₂ (2.3 mg, 0.006 mmol, 5 mol %), AgF (22.8 mg, 0.18 mmol) and toluene (2 mL). The tube was then sealed with a screw-cap and taken out of the glove box, wrapped in aluminum foil and placed into a preheated 130° C. oil bath with adequate stirring. After 18 h the tube was removed from the oil bath and allowed to cool to room temperature. 4-Fluorotoluene (6.5 μL, 0.06 mmol, 0.5 equivalent) and dodecane (27.3 μL, 0.12 mmol, 1 equivalent) were added as standards. The reaction mixture was filtered through a glass filter and a plug of Celite® to remove all solids. The clear pale yellow solution was then analyzed by ¹⁹F NMR (282 MHz) for yield and GC for conversion as well as reduction product. The yield is determined by comparing integration of the ¹⁹F NMR resonance of 4-fluorotoluene (−118.0 ppm) and that of 4-fluoro-3-methylbenzonitrile (−108.5 ppm, 0.103 mmol, 74% yield). The ¹⁹F-NMR chemical shift of the product corresponds to that of the authentic sample purchased from Alfa Aesar.

Methyl 4-fluoro-3-methylbenzoate. Methyl 4-bromo-3-methylbenzoate (27.5 mg, 0.12 mmol), BrettPhos (6.4 mg, 0.012 mmol, 10 mol %), (COD)Pd(CH₂TMS)₂ (2.3 mg, 0.006 mmol, 5 mol %), AgF (22.8 mg, 0.18 mmol, 1.5 equivalents) and toluene (2 mL) were added to an oven dried resealable screw-top test tube equipped with a stir bar. The tube was then sealed with a cap and taken out of the glove box, wrapped in aluminum foil and placed into a preheated 130° C. oil bath with adequate stirring. After 18 h, the tube was removed from the oil bath and allowed to cool to room temperature. p-Fluorotoluene (6.5 μL, 0.06 mmol, 0.5 equivalent) and dodecane (27.3 μL, 0.12 mmol, 1 equivalent) were added as standard. The reaction mixture was filtered through a glass filter and a plug of Celite® to remove all solids. The clear yellow solution was then analyzed by ¹⁹F NMR (282 MHz) for yield and GC for conversion as well as reduction product. The yield is determined by comparing integration of the ¹⁹F NMR resonance of p-Fluorotoluene (−118 ppm) and that of methyl 4-fluoro-3-methylbenzoate (−106 ppm, 0.100 mmol, 83% yield). GC/MS analysis of the sample confirmed that the only compound in solution is methyl 4-fluoro-3-methylbenzoate.

4-Fluoroquinoline. 4-Bromoquinoline (250 mg, 1.2 mmol), BrettPhos (64 mg, 0.12 mmol, 10 mol %), (COD)Pd(CH₂TMS)₂ (23 mg, 0.06 mmol, 5 mol %), AgF (228 mg, 1.8 mmol, 1.5 equivalents) and toluene (20 mL) were added to a flame-dried 50-mL Schlenk flask equipped with a stir bar. The Schlenk flask was sealed with a glass stopper and removed from the glove box, wrapped in aluminum foil and placed into a preheated 130° C. oil bath. After 18 h, the flask was removed from the oil bath and allowed to cool to room temperature. The solution was filtered through Celite® to afford a clear yellow liquid. The solvent was removed and the product was purified by column chromatography (CH₂Cl₂) to afford a clear yellow oil (131 mg, 0.89 mmol, 74%).

1-Fluoro-2-methyl-4-nitrobenzene. Prepared from 1-bromo-2-methyl-4-nitrobenzene accord to the same procedure as 4-fluoroquinoline (150 mg, 0.97 mmol, 81%) described above.

4-Fluorobenzonitrile. In a nitrogen-filled glovebox, a screw-cap vial was charged with [(COD)Pd(CH₂SiMe₃)₂] (1.9 mg, 5.0 μmmol, 5 mol %), BrettPhos (5.4 mg, 10 μmmol, 10 mol %), silver fluoride (110 mg, 0.87 mmol, 8.7 eq), 4-bromobenzonitrile (18.2 mg, 0.1 mmol) and toluene (2 mL). The vial was capped, taken out of the glovebox and stirred for 15 h at 130° C. After the mixture cooled to room temperature (RT), 4-fluorotoluene (0.1 mmol) was added and the yield was determined by ¹⁹F-NMR (integration relative to the signal of 4-fluorotoluene, δ=−118.8 ppm). Yield of product: 7%. ¹⁹F-NMR: δ=−104.6 (product), −148.7 ppm (unidentified signal).

Selected Chloroarenes and Iodoarenes. To an oven-dried resealable tube equipped with a stir bar was added aryl halide as depicted in FIG. 20 (0.12 mmol), BrettPhos (6.4 mg, 0.012 mmol, 10 mol %), (COD)Pd(CH₂TMS)₂ (2.3 mg, 0.006 mmol, 5 mol %), AgF (23 mg, 0.18 mmol) and toluene (2 mL). The tube was then sealed with a screw-cap and taken out of the glove box, wrapped in aluminum foil and placed into a preheated oil bath at the indicated temperature with adequate stirring. After 12, the tube was removed from the oil bath and allowed to cool to room temperature. 4-Fluorotoluene (13.2 μL, 0.12 mmol, 1 equiv) and dodecane (27.3 μL, 0.12 mmol, 1 equiv) were added as standards. The reaction mixture was filtered through a glass filter and a plug of Celite® to remove all solids. Then, it was analyzed by ¹⁹F NMR (282 MHz) for yield and GC for conversion.

### Example 2

### Synthesis of Fluoroarenes from Trifluoromethanesulfonates

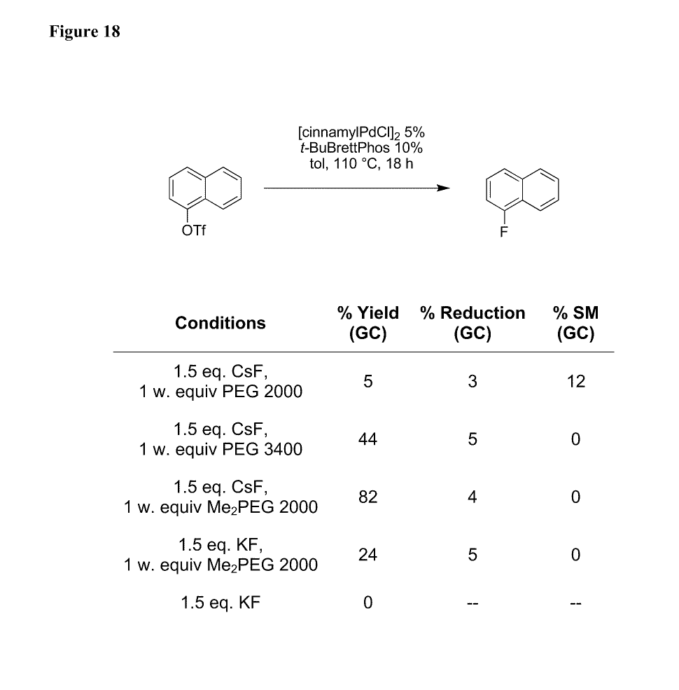

1-Fluoronaphthalene. To an oven-dried screw-cap test tube equipped with a magnetic stir bar was added 1-naphthyl trifluoromethanesulfonate (25 μL, 0.127 mmol, 1.0 eq), cesium fluoride (29.3 mg, 0.191 mmol, 1.5 eq), [Pd(cinnamyl)Cl]₂ (3.3 mg, 7 μmol, 5 mol %) and L1 (6.6 mg, 13 μmol, 10 mol %) inside a glovebox. See FIG. 19. The test tube was then sealed off with a screw-cap and taken out of the glovebox. Toluene (2 mL) was promptly added via syringe in such a manner that any reagent on the side of the test tube was washed down to the bottom of the tube. The test tube was then placed in a pre-heated oil bath at the indicated temperature and it was stirred for 18 h. After cooling to room temperature, dodecane (28.9 μL) was added, the reaction was diluted with EtOAc (˜1 mL) and the resulting mixture was filtered through a plug of Celite® and it was analyzed by GC.

2-Fluorobiphenyl. The preparation of 2-fluorobiphenyl is depicted in FIG. 8 (bottom). To an oven-dried screw-cap test tube equipped with a magnetic stir bar was added 2-biphenyl trifluoromethanesulfonate (302 mg, 1 mmol, 1.0 eq), cesium fluoride (304 mg, 2 mmol, 2.0 eq), [Pd(cinnamyl)Cl]₂ (10.4 mg, 0.02 mmol) and tBuBrettPhos (29.4 mg, 0.06 mmol) inside a glovebox. The test tube was then sealed off with a screw-cap and taken out of the glovebox. Toluene (5 mL) was promptly added via syringe in such a manner that any reagent on the side of the test tube was washed down to the bottom of the tube. The test tube was then placed in a pre-heated oil bath at 110° C. and stirred for 12 h. After cooling to room temperature, the reaction was diluted with EtOAc (about 5 mL) and the resulting mixture was filtered through a plug of Celite®. An aliquot of the filtrate was taken out for GC analysis. The rest of the filtrate was concentrated under reduced pressure and purified by flash chromatography on silica gel using hexane to give the title compound as a white solid; m.p. 72-74° C.; yield: 137 mg (81% yield). The spectroscopic data correspond to those reported in the literature. L.-C. Liang, P.-S. Chien, M.-H. Huang, Organometallics 24, 353 (2005). ¹H NMR (400 MHz, CDCl₃) δ: 7.55 (d, J=8.0, 2H), 7.47-7.40 (m, 3H), 7.39-7.27 (m, 2H), 7.24-7.11 (m, 2H). ¹³C NMR (100 MHz, CDCl₃) δ: 159.8 (d, J=247.7), 135.8 (d, J=1.0), 130.8 (d, J=3.5), 129.1 (d, J=2.9), 129.0 (d, J=8.3), 128.4, 127.6, 124.4 (d, J=3.7), 116.1 (d, J=22.8). ¹⁹F NMR (282 MHz, CDCl₃) δ: −118.4. IR (neat, cm⁻¹): 3023, 1614, 1567, 1506, 1389, 1258, 1187, 1282, 1061, 925, 861, 834.

General Procedure 1. In a nitrogen-filled glovebox, [(cinammyl)PdCl]₂ (2.5 mg, 5.0 μmmol, 2.5 mol %), tBuBrettPhos (5.8 mg, 12 μmmol, 6 mol %) and cesium fluoride (91 mg, 0.6 mmol, 3 eq) were added to a screw-cap vial. Then, toluene (1 mL) and aryl triflate (0.2 mmol) were added. The vial was capped, taken out of the glovebox and stirred for 12-15 h at 130° C. After the mixture cooled to RT, 1-fluoronaphthalene (0.2 mmol) was added and the yield was determined by ¹⁹F-NMR (integration relative to the signal of 1-fluoronaphthalene, δ=−123.9 ppm).

2,4,6-Trimethylfluorobenzene. According to procedure 1,2,4,6-trimethylphenyl trifluoromethanesulfonate (54 mg) was transformed (86%). ¹⁹F-NMR: δ=−127.9 ppm.

2,4-Dmethylfluorobenzene. According to procedure 1,2,4-dimethylphenyl trifluoromethanesulfonate (51 mg) was transformed (79%). ¹⁹F-NMR: δ=−123.2 ppm.

2,3,5-Trimethylfluorobenzene. According to procedure 1,2,3,5-trimethylphenyl trifluoromethanesulfonate (54 mg) was transformed (84%). ¹⁹F-NMR: δ=−119.3 ppm.

2,4,5-Trimethylfluorobenzene. According to procedure 1,2,4,5-trimethylphenyl trifluoromethanesulfonate (54 mg) was transformed (83%). ¹⁹F-NMR: δ=−123.4 ppm.

2-Methoxy-5-methylfluorobenzene. According to procedure 1,2-methoxy-5-methylphenyl trifluoromethanesulfonate (54 mg) was transformed (39%). ¹⁹F-NMR: δ=−135.3 ppm.

General Procedure 2. In a nitrogen-filled glovebox, [(COD)Pd(CH₂SiMe₃)₂] (3.8 mg, 10 μmmol, 5 mol %), tBuBrettPhos (9.7 mg, 20 μmmol, 10 mol %) and cesium fluoride (91 mg, 0.6 mmol, 3 eq) were added to a screw-cap vial. Then, toluene (1 mL) and aryl triflate (0.2 mmol) were added. The vial was capped, taken out of the glovebox and stirred for 12-15 h at 110° C. After the mixture cooled to RT, 4-fluorotoluene (0.2 mmol) was added and the yield was determined by ¹⁹F-NMR (integration relative to the signal of 4-fluorotoluene, δ=−118.8 ppm).

3-Acetylfluorobenzene. According to procedure 2,3-acetylphenyl trifluoromethanesulfonate (54 mg) was transformed. Combined yield of isomers: 4%. ¹⁹F-NMR: δ=−107.1, −111.8, −112.8 ppm.

Methyl 3-fluorobenzoate. According to procedure 2, methyl 3-(trifluoromethylsulfonyloxy)benzoate (57 mg) was transformed. Combined yield of isomers: 49%, A:B=95:5. ¹⁹F-NMR: δ=−113.0 (desired isomer, A), −107.0 ppm (regioisomer, B).

3-Fluorobenzonitrile. According to procedure 2,3-cyanophenyl trifluoromethanesulfonate (50 mg) was transformed. Combined yield of isomers: 31%, A:B=96:4. ¹⁹F-NMR: δ=−110.8 (desired isomer, A), −104.6 ppm (regioisomer, B).

1-Chloro-2-fluorobenzene. According to procedure 2,2-chlorophenyl trifluoromethanesulfonate (52 mg) was transformed. Yield of product: 12%. ¹⁹F-NMR: δ=−138.5, −131.2, −115.6 ppm (product).

General Procedure 3. In a nitrogen-filled glovebox, [(cinammyl)PdCl]₂ (2.5 mg, 5.0 μmmol, 2.5 mol %), tBuBrettPhos, MeBuBrettPhos or iPrtBuBrettPhos (15 μmmol, 7.5 mol %) and cesium fluoride (76 mg, 0.5 mmol, 2 eq) were added to a screw-cap vial. Then, solvent (1 mL) and aryl triflate (0.25 mmol) were added. The vial was capped, taken out of the glovebox and stirred for 12-15 h at T ° C. After the mixture cooled to RT, 4-fluorotoluene (28 μL, 0.25 mmol, 1 eq.) was added and the yield and regioselectivity was determined by ¹⁹F-NMR.

2,4,6-Trimethylfluorobenzene. According to procedure 3,2,4,6-trimethylphenyl trifluoromethanesulfonate (67 mg) was transformed (T=150° C., L=tBuBrettPhos, solvent=toluene, NMR yield=76%). ¹⁹F-NMR: δ=−127.9 ppm.

2-Fluoronaphthelene. According to procedure 3,2-naphthyl trifluoromethanesulfonate (69 mg) was transformed (T=110° C., L=tBuBrettPhos, solvent=toluene, NMR yield=77%, no regioisomers). ¹⁹F-NMR: δ=−114.9 ppm.

3-Fluorobiphenyl. According to procedure 3,3-biphenyl trifluoromethanesulfonate (77 mg) was transformed. (T=120° C., L=tBuBrettPhos, solvent=cyclohexane, 100% conversion, regioselectivity=6:1 (3-fluorobiphenyl: 4-fluorobiphenyl)). ¹⁹F-NMR: δ=−114.1 ppm.

4-n-Butyl-fluorobenzene. According to procedure 3,4-n-butylphenyl trifluoromethanesulfonate (70 mg) was transformed. Result 1: T=130° C., L=tBuBrettPhos, solvent=cyclohexane, 100% conversion, regioselectivity=6.5:1 (4-n-butyl-fluorobenzene: 3-n-butyl-fluorobenzene); Result 2: T=130° C., L=MetBuBrettPhos, solvent=cyclohexane, 100% conversion, regioselectivity=11:1,4-n-butyl-fluorobenzene: 3-n-butyl-fluorobenzene; Result 3: T=130° C., L=iPrtBuBrettPhos, solvent=cyclohexane, 95% conversion, regioselectivity=4:1,4-n-butyl-fluorobenzene: 3-n-butyl-fluorobenzene). ¹⁹F-NMR: δ=−118.1 ppm.

### Example 3

### Synthesis of Pd—Br and Pd—F Complexes

Preparation, isolation, handling, and storing of the palladium complexes were carried out in a nitrogen-filled glovebox.

General Procedure 1. A solution of BrettPhos (1.5 eq) and aryl bromide (6.0 eq) in THF (15 mL mmol⁻¹) was added to a vial containing (COD)Pd(CH₂TMS)₂ (1.0 eq). The resulting yellow solution was stirred for 48 h and then layered with twice the volume of pentane and left standing. After 24 h, the resulting solid was filtered off, washed with pentane and dried under vacuum.

General Procedure 2. To a solution of (BrettPhos)Pd(Ar)(Br) complex (0.1-0.2 mmol) in dichloromethane (40 mL mmol⁻¹), silver fluoride (5 eq) was added. Under exclusion of light, the suspension was stirred rapidly for 18 h. The mixture was then filtered through Celite® and the solvent was evaporated. The remaining solid was dissolved in a minimum amount of dichloromethane and layered with twice the volume of diethyl ether or pentane. When the solution was not clear but still contained black particles, filtration through Celite®, evaporation of solvent, solving in dichloromethane and layering with diethyl ether or pentane was repeated. (Washing the Celite® after filtration with dichloromethane afforded more of the black particles to pass). The solution was stored in a freezer for 24 h, and the resulting solid was filtered off, dried under vacuum and stored in a freezer.

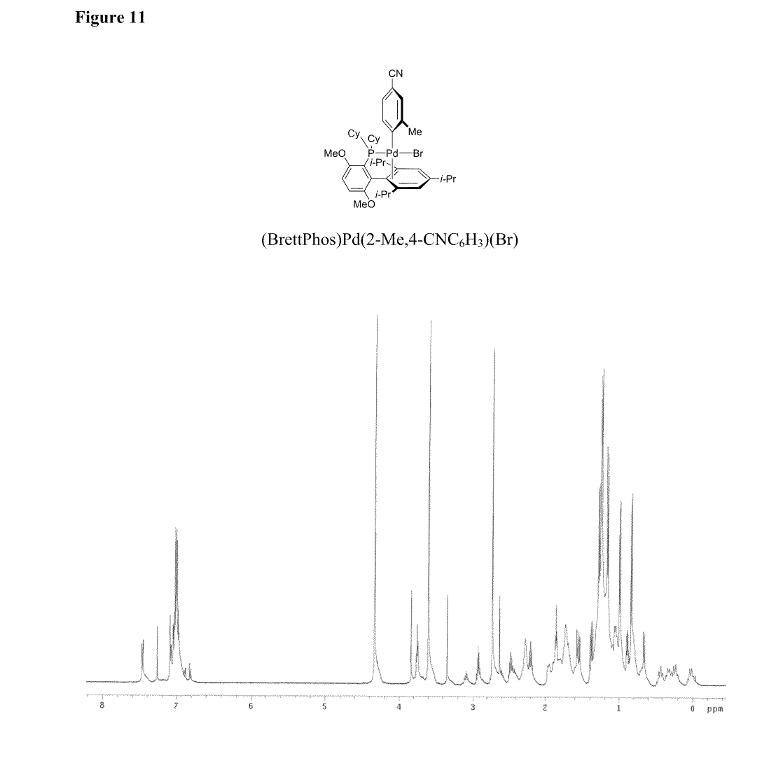

Preparation of (BrettPhos)Pd(2-Me,4-CF₃C₆H₃)(Br). According to general procedure 1, (COD)Pd(CH₂TMS)₂ (144 mg, 0.37 mmol) was reacted with BrettPhos (300 mg, 0.56 mmol) and 2-methyl-4-trifluoromethylbromobenzene (531 mg, 2.22 mmol) in 6 mL THF to afford 218 mg (247 μmmol, 67%) of the desired complex as a white powder. ³¹P-NMR (162 MHz, CDCl₃): δ=43.9 ppm. ¹⁹F-NMR (376 MHz): δ=−62.1 ppm. ¹H (500 MHz, CDCl₃): complex spectrum, shown in FIG. 9.

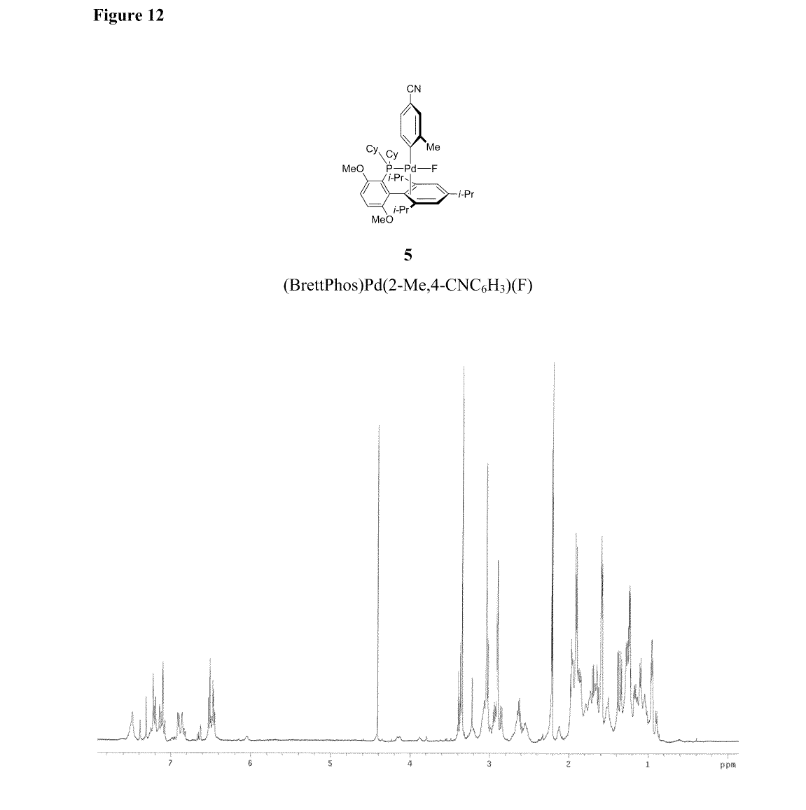

Preparation of (BrettPhos)Pd(2-Me,4-CF₃C₆H₃)(F), complex 4. According to general procedure 2, (BrettPhos)Pd(2-Me,4-CF₃C₆H₃)(Br) (61 mg, 69 μmmol) was reacted with AgF (47 mg, 0.37 mmol) in CH₂Cl₂ (3 mL) to afford 42 mg (51 μmmol, 74%) of the desired complex as a yellow powder. ³¹P-NMR (121.5 MHz, toluene): δ=42.09 (d, J=174 Hz); ¹⁹F-NMR (282.4 MHz, toluene): δ=−207.6 ppm (d, 1F, J=174 Hz), −61.5 (s, 3F). ¹H-NMR (500 MHz, d⁸-toluene): complex spectrum, shown in FIG. 10.

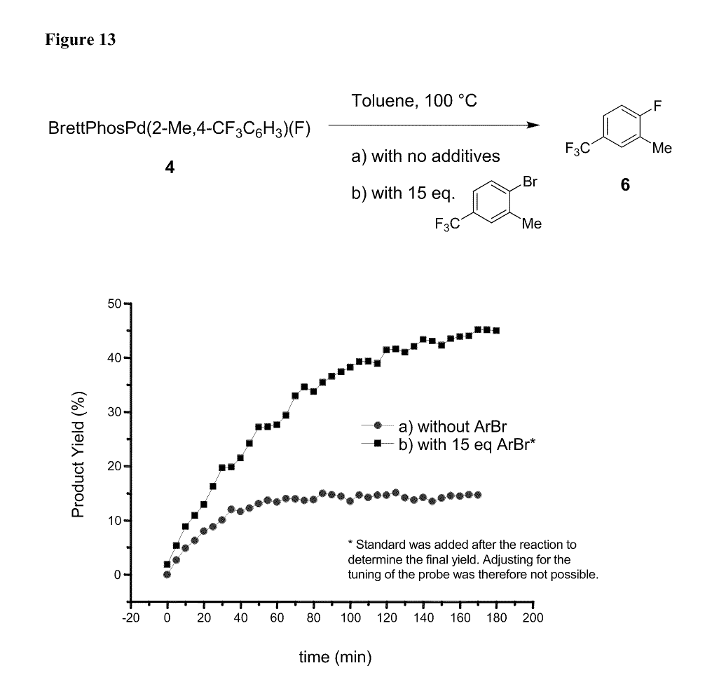

Preparation of (BrettPhos)Pd(2-Me,4-CNC₆H₃)(Br). According to general procedure 1, (COD)Pd(CH₂TMS)₂ (193 mg, 0.50 mmol) was reacted with BrettPhos (400 mg, 0.75 mmol) and 2-methyl-4-cyanobromobenzene (584 mg, 2.98 mmol) in 10 mL THF to afford 281 mg (0.33 mmol, 67%) of the desired complex as a white powder. ³¹P-NMR (121 Hz, CDCl₃): δ=35.9, 45.4 ppm. ¹H (500 MHz, CDCl₃): complex spectrum, shown in FIG. 11.

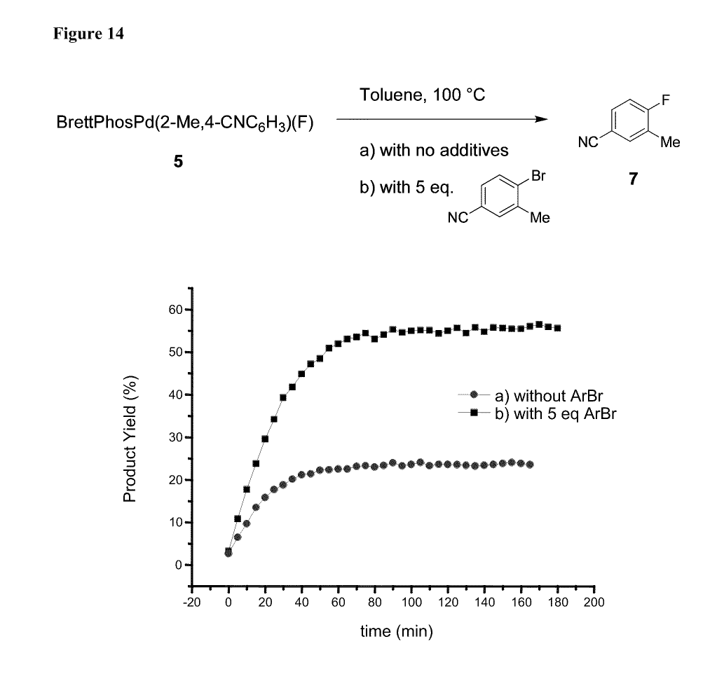

Preparation of (BrettPhos)Pd(2-Me,4-CNC₆H₃)(F), complex 5. According to general procedure 2, (BrettPhos)Pd(2-Me,4-CNC₆H₃)(Br) (150 mg, 0.18 mmol) was reacted with AgF (114 mg, 0.90 mmol) in CH₂Cl₂ (7.5 mL) to afford 97 mg (0.13 mmol, 70%) of the desired complex 5 as a slightly yellow powder. ³¹P-NMR (121 MHz, toluene): δ=41.90 (d, J=173 Hz); ¹⁹F-NMR (282 MHz, toluene): δ=−207.7 ppm (d, J=173 Hz). ¹H-NMR (500 MHz, d⁸-toluene): complex spectrum, shown in FIG. 12.

### Example 4

### Reductive Elimination from Pd—F Complexes

General Procedure. In a nitrogen-filled glovebox, a screw-cap NMR tube was charged with (BrettPhos)Pd(Ar)(F) complex, aryl bromide (where applicable) and toluene. The tube was capped and taken out of the box and standard (p-fluorotoluene) was added via syringe. In a Varian 500 spectrometer, a broadband gXH probe was tuned to ¹⁹F and heated to 100° C. Over the course of 2-3 h, a ¹⁹F-NMR spectrum was obtained every 5 minutes with 5 minutes acquisition time per spectrum. Every spectrum was normalized to the standard to account for differences in the tuning of the NMR probe.

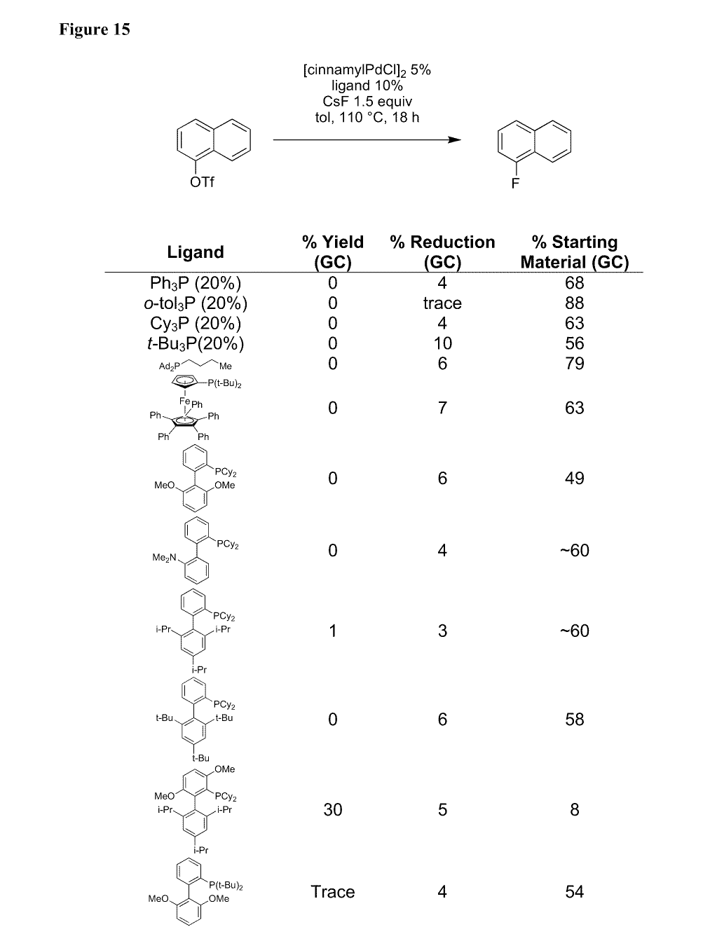

Reductive Elimination of 4. See FIG. 13.
a) 6.0 mg (BrettPhos)Pd(2-Me,4-CF₃C₆H₃)(F) (5.9 μmol), 0.6 mL toluene. The fitted curve shows t_{1/2}=16 min.
b) 5.4 mg (BrettPhos)Pd(2-Me,4-CF₃C₆H₃)(F) (6.6 μmol), 22.8 mg ArBr (96 μmol, 15 eq), 0.6 mL toluene. Standard was added after the reaction.
c) The fitted curve shows t_{1/2}=47 min.

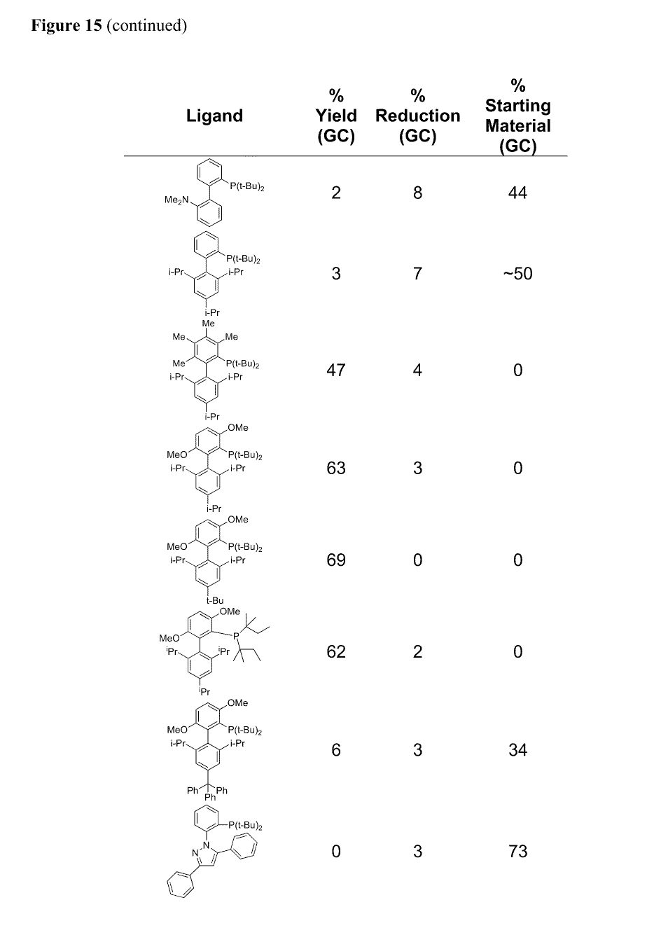

Reductive Elimination of 5. See FIG. 14.
a) 10 mg (BrettPhos)Pd(2-Me,4-CNC₆H₃)(F) (13 μmmol), 1 mL toluene. The fitted curve shows t_{1/2}=14 min.
b) 10 mg (BrettPhos)Pd(2-Me,4-CNC₆H₃)(F) (13 μmmol), 12.5 mg ArBr (64 μmmol, 5 eq), 0.6 mL toluene.
c) The fitted curve shows t_{1/2}=18 min.

### Example 5

### Ligand Screen

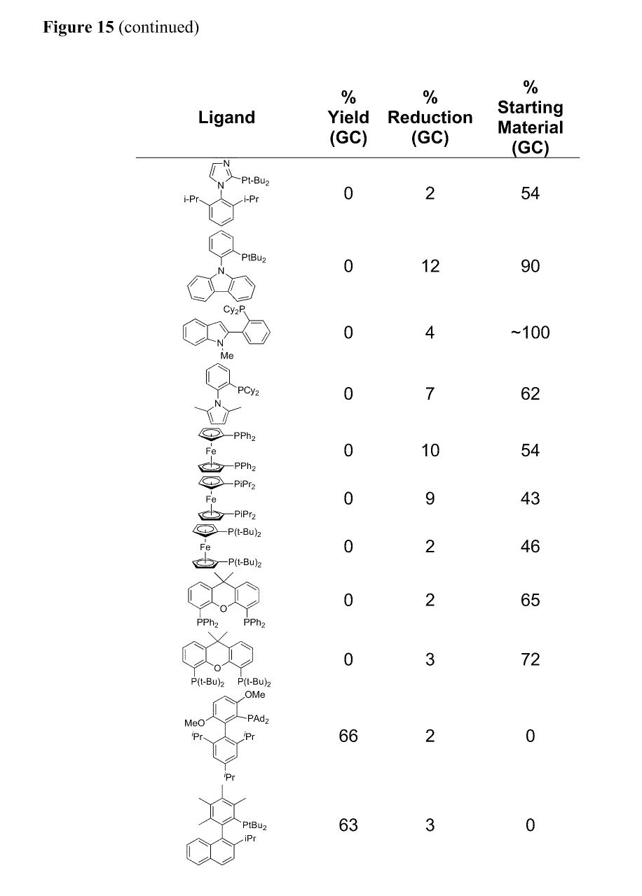

The results of a ligand screen are shown in FIG. 15.

General Procedure. To an oven-dried screw-cap test tube equipped with a magnetic stir bar was added 4-bromo nitrobenzene (20 mg, 0.1 mmol, 1.0 eq), cesium fluoride (30 mg, 0.2 mmol, 2.0 eq), (COD)Pd(CH₂TMS)₂ (3.9 mg, 10 μmol, 10 mol %) and Ligand (10 μmol, 10 mol %) inside a glovebox. The test tube was then sealed with a screw-cap and taken out of the glovebox. Toluene (1 mL) was promptly added via syringe in such a manner that any reagent on the side of the test tube was washed down to the bottom of the tube. The test tube was then placed in a pre-heated oil bath at 130° C. and it was stirred for 10 h. After cooling to room temperature, dodecane (22.7 μL) was added, the reaction was diluted with EtOAc (˜1 mL) and the resulting mixture was filtered through a plug of Celite® and it was analyzed by GC.

### INCORPORATION BY REFERENCE

All of the U.S. patents and U.S. published patent applications cited herein are hereby incorporated by reference.

### EQUIVALENTS

Those skilled in the art will recognize, or be able to ascertain using no more than routine experimentation, many equivalents to the specific embodiments of the invention described herein. Such equivalents are intended to be encompassed by the following claims.

We claim:

1. A method represented by Scheme 1: 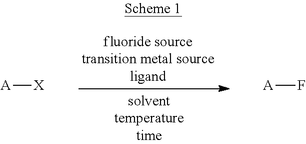
wherein, independently for each occurrence,
A is selected from the group consisting of optionally substituted aryl, optionally substituted heteroaryl and 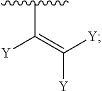
Y is hydrogen, alkyl, cycloalkyl, aryl, aralkyl, heteroaryl, or heteroaralkyl;
X is selected from the group consisting of —Cl, —Br, —I, —OS(O)₂alkyl, —OS(O)₂ perfluoroalkyl, and —OS(O)₂aryl;
the fluoride source is an alkali metal fluoride, an alkali earth metal fluoride or a transition metal fluoride;
the transition metal source comprises Ni, Pd or Pt; and
the ligand is a phosphine-containing ligand, and is achiral or, when chiral, is a single stereoisomer or a mixture of stereoisomers.

2. The method of claim 1, wherein A is optionally substituted aryl or optionally substituted heteroaryl.

3. The method of claim 1, wherein A is an optionally substituted phenyl or optionally substituted naphthyl.

4. The method of claim 1, wherein A is selected from the group consisting of

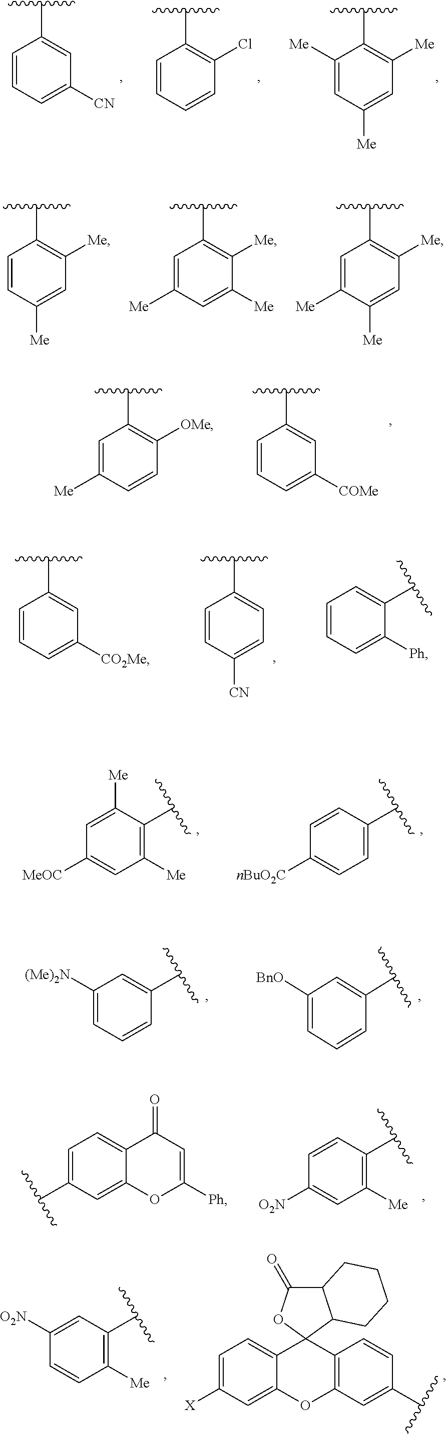

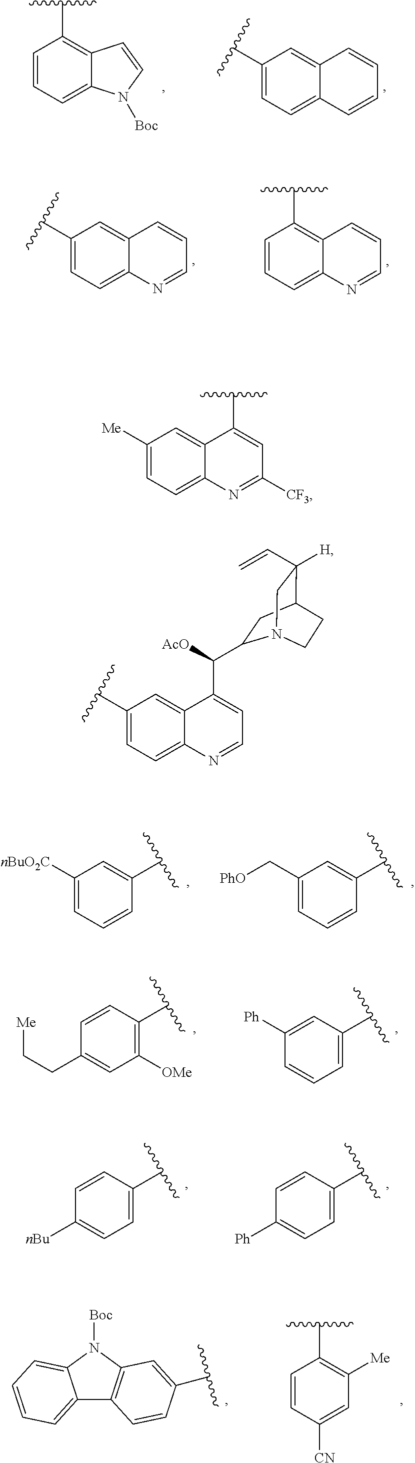

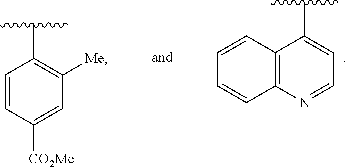

5. The method of claim 1, wherein X is selected from the group consisting of —Cl, —Br, —I, —OS(O)₂alkyl, —OS(O)₂ perfluoroalkyl, and —OS(O)₂aryl.

6. The method of claim 1, wherein X is —Br or —OTf.

7. The method of claim 1, wherein the fluoride source is AgF, CsF or KF.

8. The method of claim 1, wherein the fluoride source comprises ¹⁸F⁻.

9. The method of claim 1, wherein the transition metal source comprises Pd.

10. The method of claim 1, wherein the transition metal source is selected from the group consisting of (COD)Pd(CH₂TMS)₂, Pd₂ dba₃, [allylPdCl]₂, [cinnamylPdCl]₂ and tmedaPdMe₂.

11. The method of claim 1, wherein the ligand is a monophosphine ligand.

12. The method of claim 1, wherein the ligand is a biphenyl monophosphine ligand, phenyl-heteroaryl monophosphine ligand or heteroaryl-heteroaryl monophosphine ligand.

13. The method of claim 1, wherein the ligand is represented by 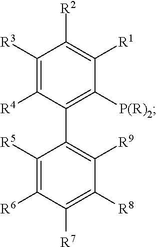
R is alkyl, adamantyl, fluoroalkyl, cycloalkyl, aryl, heteroaryl, heterocyclyl, aryloxy, or heteroaryloxy; R¹ is hydrogen, alkyl, alkoxy, fluoroalkyl, fluoroalkoxy, or dialkyl amino; R² is hydrogen or alkyl; R³ is hydrogen or alkyl; R⁴ is hydrogen, alkyl, alkoxy, fluoroalkyl, fluoroalkoxy, or dialkyl amino; R⁵ and R⁶ are, independently, hydrogen, alkyl, fluoroalkyl or alkoxy, or taken together are —C(H)═C(H)—C(H)═C(H)—; R⁷ is hydrogen, alkyl, fluoroalkyl or —C(aryl)₃; R⁸ is hydrogen, alkyl or alkoxy; and R⁹ is hydrogen or alkyl.

14. The method of claim 13, wherein R is selected from the group consisting of cyclohexyl, t-butyl, adamantyl, trifluoromethyl, phenoxy, —C(Me)₂Et,

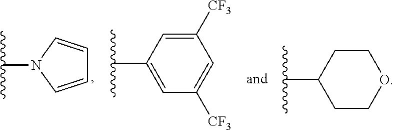

15. The method of claim 13, wherein R¹ is methyl, methoxy, i-propyloxy, trifluoromethyl, trifluoromethoxy, or dimethyl amino.

16. The method of claim 13, wherein R² is hydrogen or methyl.

17. The method of claim 13, wherein R³ is hydrogen or methyl.

18. The method of claim 13, wherein R⁴ is hydrogen, methyl, or methoxy.

19. The method of claim 13, wherein R⁵ is hydrogen, i-propyl, or methoxy.

20. The method of claim 13, wherein R⁶ is hydrogen, trifluoromethyl, or methoxy.

21. The method of claim 13, wherein R⁵ and R⁶ taken together are —C(H)═C(H)—C(H)═C(H)—.

22. The method of claim 13, wherein R⁷ is hydrogen, trifluoromethyl, i-propyl, t-butyl, or —C(Ph)₃.

23. The method of claim 13, wherein R⁸ is hydrogen, trifluoromethyl, or methoxy.

24. The method of claim 13, wherein R⁹ is hydrogen, methoxy, or i-propyl.

25. The method of claim 1, wherein the ligand is selected from the group consisting of 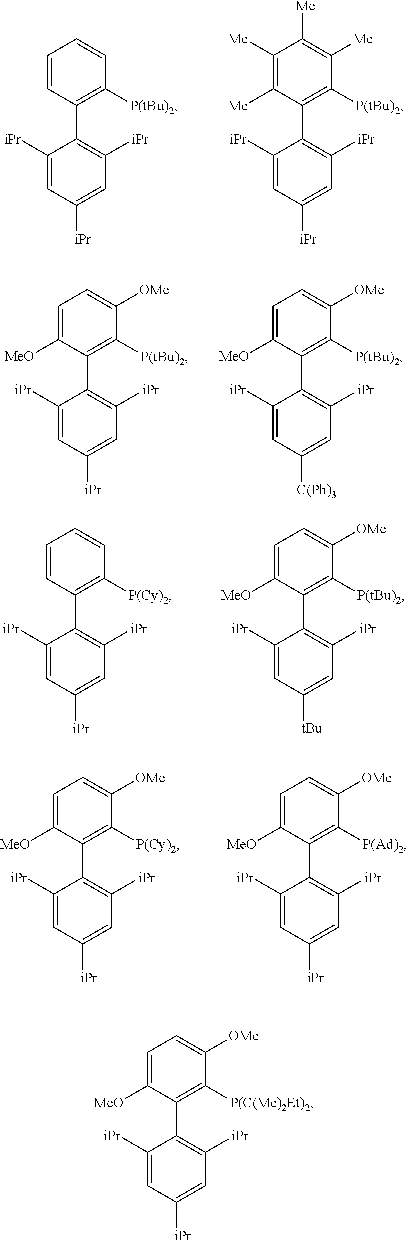 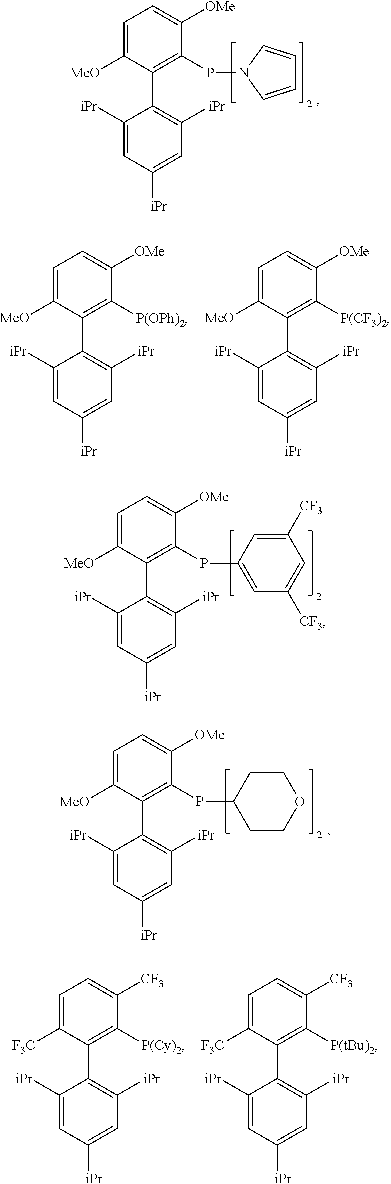 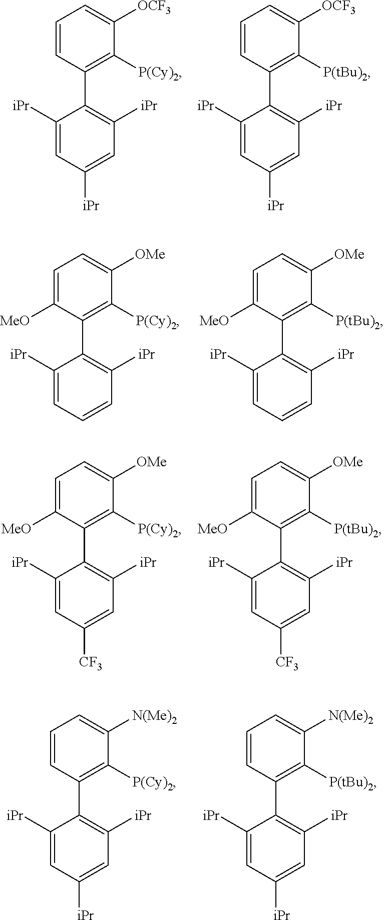 [chemical structure]
